(19) United States
(12) Patent Application Publication
(10) Pub. No.: US 2010/0295940 A1
(43) Pub. Date: Nov. 25, 2010

(54) METHOD AND APPARATUS FOR DETERMINING DISTANCE

(75) Inventor: Rudolf Schwarte, Netphen/Dreis-Tiefenbach (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: I F M ELECTRONIC GMBH, Essen (DE)

(21) Appl. No.: 12/738,604

(22) PCT Filed: Oct. 16, 2008
(86) PCT No.: PCT/EP08/08770

§ 371 Date: Aug. 6, 2010

(30) Foreign Application Priority Data
Oct. 16, 2007 (DE) 10 2007 050 052.3

(51) Int. Cl. H04N 7/18

(52) U.S. Cl. 348/135; 348/E07.085

(57) ABSTRACT

A method for determining the distance of at least one object in a space relative to an image capturing device. A picture generating element displays at least a part of a spatial image captured by a picture generating element at a certain setting angle and a sensor element signal is generated corresponding to a sensor element. The relative velocity of movement of the image capturing device relative to the object is determined, and by evaluating the sensor element signals of at least two sensor elements—voxel—a spatial image angular speed is determined and the object distance is determined using the relative velocity of the image capturing device, the orthogonal object angular speed attained from the spatial image angular speed of the object displayed on the sensor elements and the setting angle of the object. As a result, comprehensive detection of object distances is possible with simple technical media.

### BACKGROUND OF THE INVENTION

1. Field of the Invention

The invention relates to a method for determining the distance R of at least one object found in a space relative to an image capturing device having a picture generating element and a sensor, wherein the sensor consists of multiple sensor elements arranged essentially flat next to one another, the picture generating element displaying at least a part of the space on the sensor—spatial image—wherein a part of the space captured by the picture generating element at a certain setting angle α is displayed on a certain sensor element and the sensor elements generate corresponding sensor element signals. Furthermore, the invention relates to a device for determining the distance to at least one object found in a space, having a picture generating element, a sensor and a signal processing unit, wherein the sensor consists of multiple sensor elements arranged essentially flat next to one another, the picture generating element is able to display at least a part of the space on the sensor—spatial image—wherein a part of the space captured by the picture generating element at a certain setting angle α can be displayed on a certain sensor element and can be generated by a sensor element signal corresponding to the sensor element.

2. Description of Related Art

In the field of measurement engineering, in particular, also in industrial applications in the field of process measurement engineering, diverse methods have been known for a long time that deal with determining the distance of an object to an image capturing device in the broadest sense. These methods make use of very different physical effects, are associated with very different complexities in their technical implementation and are tied to different limiting conditions of their surroundings.

When speaking of a method here, which serves to determine the distance R “of at least one object found in a space” to an image capturing device, then it is not meant to be limiting that only the distances to certain objects in the space are detected, but that the method can also be used to detect a plurality of distance information that describe distances of the entire space, at least insofar as the resolution of the underlying technical equipment allows. Reference to the distance of an object only makes it easier to exemplify the method being discussed.

When saying that the image capturing device displays the space on the sensor, then it is possible that, at first, the optical imaging of visible light is understood in a limiting manner. Of course, this is not a limitation; this could be any arbitrary electromagnetic radiation, in particular that in the terahertz range. Even the use of acoustic image capturing devices is possible.

A wide-spread known method for determining distances is, for example, triangulation, with which only the distance of one object can be detected that is found in exactly a certain direction from the image capturing device. In exactly this direction, for example, a beam of light is emitted from the active measuring device, which is at least partially reflected by the object. The so-called triangulation triangle consisting of sending beam, receiving beam and the given optical base is formed from a receiving device shifted to the side of the optical base opposite the light source. The triangle is completely defined with the optical base and both measurable side angles from the sending and receiving beams. This form of distance measurement is adapted manifold in variations in practice and, e.g., also used for three dimensional object measurement by means of the stripe projection method. The triangulation triangle, however, often hampers free access of measurement, causes large defects at small triangle angles and thus only allows limited relative distances and limits the optical visual range in respect to larger space angles.

Other methods use the effects of stereometry, which is also based on triangulation, wherein the detectable object distances depend quite a bit here on the—usually very limiting—distance of the stereo image sensors and the evaluation of stereo images requires comparably complex downstream signal processing.

Stereo camera systems for three-dimensional object detection using passive lighting have to deal with various problems in the quick three-dimensional detection in natural surroundings. For example, corresponding image elements or pixel clusters in both projection images are first identified in order to determine the distance via the two azimuths of the associated receiving beams of the optical camera base to the corresponding image element of the triangulation triangle (correspondence problem). This is not possible without definite image characteristics, which e.g., are absent in a constant texture, which is why, if the case may be, suitable artificially structured lighting has to be supplemented. Another problem exists in that the three-dimensional optical flow and the target three-dimensional flow of movement often do not agree from the different perspectives of a stereo camera system, so that the correspondences cannot be determined (divergence problem). Additionally, high angular speeds in dynamic three-dimensional image capturing cause a correspondingly impaired image quality, which can often not be evaluated in terms of time and calculation requirements. Furthermore, stereo images set higher requirements on spatial image quality and thus often indicate quite erratic and insufficient spatial point density. Problems with the highly exact calibration of the position of stereo cameras are added to this, for which “Method and Device for Determining a Calibration Parameter of a Stereo Camera” WO 2006/069978 A2 suggests a solution.

“Space image” or “3D image” are to be understood here and in the following as the actual three-dimensional image of the space. In contrast to this, the—two-dimensional—image of the space image, which, for example, is obtained by means of a picture generating element—e.g., aperture and/or optics—from the space image is called “spatial image”.

Other known methods are based on the evaluation of running times of a signal, e.g., a sine-shaped or pulsed modulated optical signal, which is emitted from a measuring device, reflected from the object to be detected and received again by the measuring device, wherein the object distance can be determined using the measured signal running time provided that the signal propagation speed is known. One-dimensional running time measurement devices such as so-called laser scanners can generate space images using two-dimensional scanning of the measuring beam at a corresponding time exposure.

Yet other methods are based on interferometery, a running time measurement method using the superimposition of coherent signals, namely, on the one hand, of the emitted signal, which consists, for example, of coherent laser beams and, on the other hand, of beams reflected by the object in the same detector. Because of fundamental difficulties with ambiguous measurement results at half wavelength, interferometery is mainly used for very exact measurement of object distances—mainly as a multiple frequency method—in static settings; moving objects or image capturing devices that move on their own additionally complicate the determination of distances.

In other methods, phase running time or pulse running time differences are carried out simultaneously by means of space division multiplexing. As described in WO 9810255, ten thousands of object distances can be simultaneously determined using parallel modulated lighting of a three-dimensional setting and its imaging on a matrix of running time detectors, e.g., a PMD matrix (photonic mixer device), and using parallel mixing and correlation of the signals sent and reflected on the object. Once again, the difficulty is that very small delays of the receiving signal can be detected at high signal propagation speeds and small object distances, so that the determination of the distance cannot be carried out; it is not unusual that the time intervals to be resolved lie in the range of nanoseconds or picoseconds having associated high demands on measurement.

The method of photonic mixing in PMD pixels used by the 3D-PMD camera mixes the electric transmitter modulation signal with the optical received signal by evaluating extremely short signal delays using hardware by means of the so-called PMD “charging swing” and provides each PMD pixel with a volume element or a voxel of the space image in addition to the intensity. The disadvantage of this known implementation of a 3D camera is the great technical complexity, above all, the special active lighting of the objects, the limited range, the specially designed sensor elements as photonic mixer devices for determining distances and the troublesome surrounding light, which additionally limits the range when reflectance is weak.

As a result, it can be observed that known methods for determining the distance of an object or multiple distances of objects either can be carried out comparably easily (triangulation), but then has only a limited field of application or known methods can be used in many fields (3D-PMD camera), but are then are comparably complex to implement in terms of technology.

### SUMMARY OF THE INVENTION

The teaching of the present invention is thus based on the difficulty of providing a method and a device that makes a comprehensive and preferably quick detection of object distances possible with simple technical media, in particular in a large part of the space detected by the used image detecting device. It should be suitable for the large field of application of dynamic three-dimensional measurement.

The method according to the invention, in which the problems derived and described above are solved, is first and essentially characterized in that the relative velocity v of the movement of the image capturing device to the object—or, one and the same, the object to the image capturing device—is determined, that by evaluating the sensor element signals of at least two sensor elements—called voxels in the following—a spatial image angular speed ω_{mes,sensor} is determined and the object distance R is determined using the relative velocity v of the image capturing device, the orthogonal object angular speed ωₘₑₛ attained from the spatial image angular speed of the object displayed on the sensor elements and the setting angle α of the object.

To describe the method according to the invention, it is first assumed that the image capturing device moves straight or at least partially straight through the space at a certain speed vₜᵣ, wherein, in the case of light-sensitive sensor elements, the device could be an ordinary camera having a CMOS chip—preferably with enhanced frame grabber features and diverse evaluation possibilities for local (related to voxels) spatial image angular speeds having an ordinary lens objective as opposed to the alternative possible compound lens objective, wherein the image capturing device points with its optical axis in any direction, e.g., in automobiles mainly in the direction of the front area of the translational motion, i.e., straight section by section.

Possibly occurring rotation, e.g., automobiles and attached image detecting device driving around curves, needs to be determined in respect to each distance measurement and is preferably immediately eliminated for each measurement interval by means of optical-mechanical or calculated compensation. The movement fashioned at least section for section as pure translation of the piecewise nearly constant speed vₜᵣ covers the distance ΔL=vₜᵣ·Δt in the interval, preferably the sampling period Δt.

In its coverage, the picture generating device, for example a lens or also just a pinhole, establishes a clear relationship between a sensor element of the sensor and a certain portion of the detected space, which is displayed on a respective sensor element. The same applies, of course, for a group of sensor elements—e.g., voxels—here a clear relationship is also given by the picture generating device between the group of sensor elements and a certain part of a space displayed on the group of sensor elements by the picture generating device. The angle at which an object found in the space appears measured from the axis of the direction of movement of the image capturing device, is called setting angle. If it is assumed that the objects found in the space are fixed and a relative movement between the objects found in the space and the image capturing device only occur through the movement of the image capturing device in the space, then all objects found in the space on parallel trajectories in a respective constant object trajectory distance D to the axis of movement pass by the moving image capturing device; these trajectories thus run parallel to the trajectory of the moving image capturing device.

Infinitely far removed objects having finite object trajectory distances D arise from the view of the image capturing device first from a point in the space that lies exactly on the axis of the direction of movement of the image capturing device—setting angle 0°. With decreasing distance of the object from the image capturing device—caused by the relative velocity of the movement of the image capturing device to the object—the object appears at an increasing setting angle, insofar as it does not lie exactly on the axis of the direction of movement of the image capturing device. It is evident that, at a constant relative velocity of the straight movement of the image capturing device, the setting angle increases more and more with a decreasing distance, which is the same with an increasing speed at which the sensor scans the spatial image of the object and with correspondingly increasing angular speed of the connecting radius vector with an initially unknown length.

A demonstrative description in the camera coordinate system KKS, in the world coordinate system and in the sensor coordinate system is advantageous to better understand three-dimensional measurement according to the invention for objects in time and space with an image capturing device only recording two-dimensionally using the above-described relative movement vₜᵣ as well as using the object angular speed ωₘₑₛ—that is to be measured and is caused by vₜᵣ—of the object distance vector or radius vector \vec{R} pointing to the object. The complex geometric and kinematical procedures will be explained in more detail in the following description of the figures regarding FIGS. 1, 2a and 2b due to their importance for the function and implementation of 3D cameras or 3D video cameras according to the invention. In particular FIG. 2 simplifies and exemplifies the correlation of any relative movement of the image capturing device in space with the three possible translation directions e.g., in X-, Y-, Z-direction and the three possible rotations around the X-, Y-, Z-axes as well as the image capturing device positioned preferably respectively in the starting position of a measurement in the coordinate system.

In order to exemplify the teaching of the invention and to simplify the calculation of the target spatiotemporal relative object distances from the image capturing device as well as attainment of a continuous, quick three-dimensional object detection on the basis of the equation of circular motion, wherein one consequence of a short translational movement segment of the image capturing device relative to an object is fashioned as a short rotational movement, the method is preferably as follows:

1. The teaching of the invention allows, inter alia, for the continuous, quick, three-dimensional detection of objects on the basis of an ordinary 2D camera and uses a suitable evaluation of the known equation of circular motion, here as a vector equation \vec{v}=\vec{ω}·\vec{R}, in which the product of the vector \vec{ω}·\vec{R} only considers respectively the vector components orthogonal to one another and then, in turn determines the respective orthogonal speed vector \vec{v}. Since, in the circular motion having the radius R, the tangential speed of a point on the circle being v=2πR/T with a period T, all three vectors are perpendicular to one another, the corresponding scalar equation vₒᵣₜ=ωₒᵣₜ·Rₒᵣₜ is also valid for the circular motion. If the orthogonal variables vₒᵣₜ and ωₒᵣₜ of a circular motion are determined, then the targeted radius R=vₒᵣₜ/ωₒᵣₜ of the object distance is thus also determined. By detecting a plurality of object distances, a 3D space image can be obtained in whole.

2. The radius vectors determined for each voxel, e.g., to the sampling time point tₜₐₛₜ=k·Δt (k=0, 1, 2, . . . ), are identified in a positive Cartesian coordinate system as \vec{R} (X, Y, Z) or in a spherical coordinate system or geographical coordinate system as \vec{R} (R, ω, Φ) and are clearly associated to one another as is known using a corresponding transformation matrix.

3. The three physically possible relative rotations of the image capturing device with respect to an object in space are identified as \vec{ω}ᵣₒₜ (ω_{X}, ω_{Y}, ω_{Z}). They disturb the determination of object distances and need to be avoided or determined and compensated mathematically or using image stabilization.

4. The position and movement of the image capturing device preferably starts before each new determination of the object distances in the center of the spherical coordinate system in the Z-axis direction and having a—given or determined—translational velocity vₜᵣ assigned to the sampling period Δt. After choosing respectively the setting angle α particular to the voxel—e.g., that of the optical axis and simultaneously of the sensor center—and the spatial image angular speed ω_{mes,sensor} particular to the voxel on the sensor level as well as, if the case may be, the compensation of a relative rotation, the object distance can be determined as radius vector of a circular movement identified using at least one voxel.

5. In predetermined and unavoidable rotations of the image capturing device relative to the objects, e.g., in automobiles or in a guided robot hand, they are to be measured three-dimensionally e.g., with a rotation sensor. They can be optically-mechanically compensated or mathematically eliminated for each sampling period e.g., using the known image stabilizing method. The calculations of translation and rotation in the described camera coordinate system KKS show deviations compared to the world coordinate system WKS. The deviations are eliminated preferably by continuous tracking and respective corrected start in the WKS up to a certain limit of exactness with renewed calibration e.g., using satellite navigation (KKS-WKS matching).

6. A radius vector \vec{R} that points to one arbitrary object in space forms a setting angle α with the Z-movement axis of the image capturing device. During relative movement between the image capturing device and object, they both approach or withdraw from one another in opposite directions on parallel lines at least for the duration of one sampling period Δt a setting angle of e.g., α=45° and an object trajectory distance D having the translational velocity vₜᵣ. Should a rotation occur, the shortest distance and the highest (pseudo) angular speed for α=90° are reached after many steps, which then for Z tends to minus infinity to zero. Here, the object trajectory distance D and the object distance R are related via D=R·sin α.

7. In the geographical coordinate system—here preferably on a unit sphere with a radius of 1 for calculating the unknown radius R—an object is initially found from the view of a pinhole camera at point (θ₁, Φ₁) on the surface of the sphere having an arbitrary longitude Φ₁ and an arbitrary latitude θ₁ as well as at an associated setting angle α₁ to the movement axis of the image capturing device in the starting position sphere center or geographical center GZ. In order to describe and calculate the following movement steps with space sampling during the sampling period Δt, this three-dimensional task is preferably reduced to a two-dimensional one, in which only the respectively affected longitudinal circle is examined. Since this movement step from one sensor coordinate and space coordinate pair p₁(x₁, y₁) and P₁(θ₁, Φ₁) assigned to one another by the image capturing device to the next pair pₓ(x₂, y₂) and P₂(θ₂, Φ₂) always takes place in a certain longitudinal circle with ΔΦ˜0, all longitudinal circles can be processed layer for layer for all associated latitude or α values in the entire sensor plane or in the associated solid angle range for determining the object distances or radius vector lengths each having Φ=constant and α or θ as course parameter. Here, the coordinates of a pair are permanently assigned to one another, e.g., using a transformation or, even better, a chart for quick calculation. Latitude angles θ and setting angles α are directly linked generally via θ=90°—α or for changes Δθ=−Δα, while ΔΦ˜0 holds.

8. In the previous and subsequent observation of the projection of the object space on a sensor surface having e.g., a pixel matrix p(x, y) in the sensor coordinate system, angle distortion is initially put aside, which is warranted close to the optical axis of normal cameras and for concave spherical sensor surface—adapted e.g., to a pinhole camera serving as model. In this case, the angle and angular speeds—initially up to the description of equation (2)—are observed without distortion.

9. In the mentioned image using the picture generating element, the depth information is initially completely lost. Since, in practice, the change of radius vectors R using relatively small translation steps ΔL=vₜᵣ·Δt as opposed to the radius R from the point of view of the image capturing device is only displayed as a change in angle Δθ and ΔΦ or as angular speeds \vec{ω}_{PR}(dΦ/dt, Dθ/dt) or \vec{ω}_{PR}(ω_{X}, ω_{Y}, ω_{Z}), these are called pseudo rotations \vec{ω}_{PR} here, since there is no physical rotation. Thus, the radius or object distance can be calculated using the equation for circular motion.

10. In detail, this approximation means that the image capturing device only captures the projected orthogonal part of the translation step ΔLₒᵣₜ=vₒᵣₜΔt=ΔL·sin X=Vₜᵣ·sin α·Δt as a change of angle Δα or as a projected portion of the circumference ΔU=Δα·R, i.e., as part of the entire circumference U=2π·R. Using this, the chord ΔLₒᵣₜ is equated to the associated circular arc ΔU by approximation, wherein changes in angle Δα up to the range 20°, 30°, 50° only create small errors of 0.51%, 1.15% to 3.2%. With this equation, ΔU=ΔLₒᵣₜ or R=vₒᵣₜ·Δt and thus R=vₒᵣₜ·Δt/Δα=vₜᵣ·sin α/ωₒᵣₜ is valid.

11. The teaching of the invention consists essentially of determining the derived variables required for measuring the object distances of the surroundings in a simple manner under complex limiting conditions:
a) The setting angle α of the object is determined from the view of the image capturing device preferably initially for the optical axis OA of the picture generating device and the spatial image of the sensor image on the unit sphere with θ₀=90°−α₀ and as intersection of the central latitudinal circle θ₀ and the central longitudinal circle Φ₀ of this sensor image. Φ₀ is preferably defined at the same time as zero meridian of the geographic coordinate system. For the calculation of all object distances in the image capturing range, the constants of the α values on the latitudes and the constants of the Φ values in all longitudinal circles are used for quick calculation.
b) The translational velocity vₜᵣ is valid for all objects in equal measure. This can be given on the part of the image capturing device e.g., in a transportation means as well as by moving objects e.g., on a conveyor belt or—if not—corresponding measurements are taken. Due to the projection of the objects on the sensor surface, the radial components ΔR=ΔL·cos α, which change the length of the radius vector \vec{R}, do not affect the spatial image at all.
c) The determination of the spatial image angular speed ω_{mes,sensor} on the sensor surface or in the image capturing range is the fundamental measurement. A plurality of spatial image angular speeds ω_{mes,sensor} can be determined on one sensor having a plurality of sensor elements and voxels, each spatial image angular speed ω_{mes,sensor} for its corresponding section of space. The object angular speed ωₘₑₛ can then be easily determined from the or each individual spatial image angular speed ω_{mes,sensor}. As is shown, the projection directly provides, e.g., a 2D camera with ωₒᵣₜ=ωₘₑₛ—with the exception of the easily deskewed cos αₐₓ angle distortion for objects having a projection setting αₐₓ from the optical axis that agrees with the previously-defined setting angle α in the longitudinal circle plane. How the spatial image angular speed ω_{mes,sensor} is actually detected on the sensor surface—for example, using object tracing by means of the correlation method or other suitable methods—is irrelevant to the general idea of the invention. However, it appears that certain requirements are set on the measuring and evaluation of the angular speeds of the image shift between the sampling periods Δt that are not met by many methods described in literature. Thus new evaluation methods are suggested in the following description of further developments of the invention.

In summary: Under the described limiting conditions only such movement components of the object relatively approaching the image capturing device are detected by the sensor or sensor element that are perpendicular or orthogonal to the radius vector \vec{R}, i.e., behaving as a change in the setting angle α at which the object is viewed. For this reason, the translational relative velocity of the movement of the image capturing device \vec{v}ₜᵣ is only perceived by the sensor element of the image capturing device with its orthogonal contribution vₜᵣ·sin α=vₒᵣₜ. For the relatively small movement section vₒᵣₜ·Δt=ΔU, this known section can be plotted on the longitudinal circle having a yet unknown radius R. ΔU=R·Δαₘₑₛ results with sin Δαₘₑₛ=ΔU/R and sin Δαₘₑₛ·Δαₘₑₛ by approximation at a correspondingly high frame rate. At the same time, the setting angle α is changed by the relative translation step to an accordingly unknown Δαₘₑₛ/Δt=ωₘₑₛ. The general scalar equation of circular movement vₒᵣₜ=ωₒᵣₜ·R that can be used here and especially for the equation (1) for determining the unknown object distance directly result from these determination equations. According to the invention, the correlation according to equation 1 between the distance R of the objects found in a space to the image capturing device, the translational relative velocity of the movement of the image capturing device to the object vₜᵣ, the setting angle α of the object to the axis of the translational direction of movement of the image capturing device and the—detected from the sensor as spatial image angular speed ω_{mes,sensor} and derived from this—measured object angular speed ωₘₑₛ are used to determine the object distance R:

$$R = \frac{{v}_{ort}}{{ω}_{ort}} = \frac{{v}_{tr} \cdot sin α}{{ω}_{mes}} \qquad Equation 1$$

Under the limiting conditions described above, the object angular speed ωₘₑₛ to be measured returns solely to the translational relative velocity of the movement of the image capturing device, since there is no other movement component. According to the invention, the correlation according to equation 1 between the distance R of an object found in a space to the translational relative velocity of the movement of the image capturing device to the object vtr, the setting angle of the object to the axis of the translational movement of the image capturing device and the measured object angular speed detected on the sensor as spatial image angular speed is used to determine the object distance.

A great advantage of this method consists in that only speeds have to be measured to determine distances, the object angular speed ωₘₑₛ—resulting from the spatial image angular speed ω_{mes,sensor} of the objects displayed on the sensor—and the relative translational camera speed vₜᵣ as opposed to the objects.

Thus, there are basically no limits for absolute speeds. The simplicity and efficiency of the method become clear using insect flight e.g., of a dragonfly and fast car travel, in which the low range of our stereo vision makes up only a fraction of a possible required braking distance. Everybody uses this principle of 3D vision, wherein the one-dimensional equation 1 can be turned into three-dimensional technical vision according to the invention.

On the basis of equation 1 and its three-dimensional application according to the invention, a possibility exists for measuring spatial objects dynamically with a relatively high 3D frame rate (depending on the camera) using simple means—essentially with a 2D digital camera or 2D video camera—quasi as a 3D camera. Thereby e.g., an autonomous mobile robot can be independently navigated having at least one image capturing device and evaluation according to the invention—preferably a 3D video camera system that can look in all directions—wherein, with the help of sectionally measured translational travel speeds, sectional, simultaneous measurement and compensation of the unavoidable rotational movement and continuous correction of the camera coordinate system in autonomous travel in the world coordinate system are made possible with minimum effort without active lighting.

The following aspects regarding the picture generating element and the sensor need to be taken into consideration for technical implementation of the method according to the invention. When the picture generating element displays the space image through an object lens, a plurality of image errors are created. Nowadays, practically only corrected object lenses are used, whose geometric distortions are often negligible when the image errors reach an error still in the borderline range of e.g., 2%. The precision, however, does not avoid the perspective distortions of angles and the target angular speed ωₘₑₛ=ωₒᵣₜ on the usual level sensor plane with light shining diagonally on the sensor. The error almost never occurs near the optical axis and does not occur using the spherically adapted sensor surface, as described above. Since the error depends on the special sensor, the object angular speed distorted on the sensor element, i.e., the spatial image angular speed, is identified with ω_{mes,sensor}. On the level sensor, the angle setting on the pixel matrix of the sensor is determined from the optical axis OA(x₀, y₀) as well as in the space from the optical axis OA(θ₀, Φ₀) or OA(α₀, Φ₀) or on the geographical unit sphere using the setting angle α of the respective longitudinal circle related to the object. The error can be described with very good approximation by (ω_{mes,sensor}=ωₘₑₛ/cos α. In this case, equation 2 replaces equation 1 with ωₘₑₛ=ω_{mes,sensor}·cos α:

$$R = \frac{{v}_{tr} \cdot sin α}{{ω}_{me β , sensor} \cdot cos α} = \frac{{v}_{tr} \cdot tan α}{{ω}_{me β , sensor}} \qquad Equation 2$$

Every movement section of the image capturing device observed here points from the geographical center GZ preferably in the direction of the North Pole or Z axis. For the case that the optical axis OA of the image capturing device is sloped compared to this movement axis and thus also to the sensor plane at an angle X, a correspondingly small distortion close to the optical axis is also valid for the area of the object lens β˜α close to the axis. The same is valid for all longitudinal points in the range of sight, which lie on the same latitude θ=90°−α or setting angle. For Φ=90°, the image capturing device having the least amount of distortion lies in the range of the highest angular speed and thus also the highest accuracy. The simultaneous, required high sampling rate of picture recording is correspondingly complex and can e.g., not be fulfilled by our eyes for the instantaneous passing of a tree along the street while driving. The size of the latitude angle deviation between the latitude of the optical axis and the observed voxel or object is now responsible for estimating the distortion. This correlation of the de-skewing effect of the aligning of the axis on the section of interest of the image is taken into consideration in equation 3—also in respect to comments made for Equation (2).

$$R = \frac{{v}_{tr} \cdot sin α}{{ω}_{me β , sensor} \cdot cos ( α - β )} \qquad Equation 3$$

Before evaluating the sectionally sampled sensor element signals described later in respect to the target angular speed ωₘₑₛ, the distortions considered by approximation in equation 2 can preferably be deskewed using one of the known two-dimensional image transformations, so that the Cartesian pixel and voxel structures represent extensively non-distorted angle relations. The same holds true for the de-skewing of the hexagonal hexel and voxel structures described in the following.

The spatial image angular speed ω_{mes,sensor} can—as suggested—be obtained with very different methods using evaluation of the sensor element signal.

According to a preferred design of the invention, the spatial image angular speed X—from which the object angular speed ωₘₑₛ can finally be derived—is determined by forming a spatial frequency filter using appropriate weighting of the sensor element signals of at least two sensor elements—voxels—in at least one sensor direction, wherein the spatial frequency filter subjects at least the sensor element signals of the voxels to a spatial frequency filtering in at least two different spatial frequency filter phases φ₀, φ₉₀ and a spatial image phase φ of the voxels is determined from the obtained corresponding spatial frequency filter components A₀, A₉₀, and in that at least two spatial image phases φ of the voxels are determined by means of temporal signal sampling of the spatial frequency filter and the spatial image angular speed ω_{mes,sensor} is determined from the temporally spaced spatial image phases φ. It should be taken into consideration that the spatial image angular speed ω_{mes,sensor} of interest behaves proportionally to the temporal derivation of the spatial image phase and thus—depending on the implemented geometric relationships—can be easily obtained from the temporal derivation of the spatial image phase. Using the spatial frequency filter, a determination of the spatial image angular speed ω_{mes,sensor} is also possible from a less structured space image, which provides also a less structured spatial image on the sensor.

The resulting, unusual path to the solution of the present invention deals with measuring periodic structures in a time range, in a spatial range as well as in an angular range:
Variables in the time range: time period T; duration of an oscillation [s], time frequency f=1/T[Hz], angular frequency or angular speed to ω=2π/T=2πf.
Variables in the spatial range: spatial period; length of a wave [m], spatial frequency v=1/λ[lp/mm line pairs/mm or periods/m], spatial angular frequency or spatial angular frequency k=2π/λ.
Variables in the angular range are especially important for 2D cameras, since their sensor imaging characteristics do not allow for longitudinal measuring but only angular measuring at the space angle Ω in a space:

An ideal pixel image of ζₚᵢₓ and φₚᵢₓ in the space created with bipolar weighted pixel pair angular periods from horizontal 2ζₚᵢₓ and vertical 2φₚᵢₓ in mrad (milliradiant), wherein the horizontal and the vertical opening angle ζ_{M} or φ_{N} result from division of half of the associated amount of pixels M/2 or N/2 in the angular period of the space.

The measurement of the angular speeds ωᵣₒₜ=ωₘₑₛ are preferably carried out after de-skewing the image containing errors of a level sensor—as is shown in the following using the drawings starting with FIG. 3. Here, an image shift e.g., in the x-direction with the speed vₓ on the sensor with alternating positive and negative weighting of the random intensities of the spatial frequencies filtered in this manner with 2 pixels per period=1/2p with p being the pixel size in the sum of the amplitudes of the periods included in the time range of the periods Tₓ(t)=λₓ/vₓ or frequency fₓ(t)=vₓ/λₓ generates a signal Aₓ(t). The complex indicator Aₓ(t) represents the local spectral line obtained using the spatial frequency filter having random image amplitude and image phase and thus can deliver phase values for obtaining the associated angular speed through changes in phase per sampling period.

Hence, the spatial image angular speed X of the spatial image on the sensor is determined using a spatial frequency analysis of the sensor element signals of the signals. Similar to how in the time range certain components of the time signal can be extracted using correlation of a time-changeable signal having a harmonic oscillation in a certain frequency that has the frequency of the correlated harmonic oscillation—time frequency filter—such image components can be extracted in a spatial section using corresponding correlation of a spatially stretched signal—spatial image—having a signal—e.g., weighting from the sensor element—consisting of a harmonic oscillation with a certain spatial frequency; the components having this special spatial frequency of the spatial frequency filter.

Exactly as in the time range, frequency filtering in the spatial range is based on the special weighting of the received sensor signals, wherein the weighting normally occurs with a harmonic oscillation. The extraction effect is based on signals having another spatial frequency than that of the spatial frequency filter being averaged out, in particular when the spatial frequency filter is stretched over multiple spatial periods. According to the invention, a spatial frequency filter is formed using appropriate weighting of sensor element signals of at least two sensor elements—in the following called voxel in general—in at least one sensor direction, which allows for a spatial image according to a spatial frequency to be evaluated, which can occur in different manners, which will be discussed in detail at a later point.

According to the invention, the spatial frequency filter subjects the sensor element signals of the voxel to spatial frequency filtering in at least two different spatial frequency phases, wherein a spatial image phase of the voxel is determined from the obtained, corresponding spatial frequency filter components. In a special case, it is possible for there to be two different spatial frequency filter components around the in-phase and quadrate components of the spatial image phase of the voxel.

Due to the relative velocity of the movement of the image capturing device, the spatial image moves, in particular the spatial image of the object, whose distance is to be determined, across the sensor and thus across the sensor elements of the voxel. In a temporal sampling of the spatial frequency filter, two spatial image phases of the voxel are determined, wherein then, from the difference of both spatial image phases and the division with the sampling period, the spatial image angular speed of the spatial image is determined. As has been described above, the distance of the object can be determined from the relative velocity of the image capturing device, the spatial image angular speed of the object displayed on the voxel and the setting angle of the object.

The present invention for determining of distances serves not only to determine a distance of an object from the entire—structured—space image, but also a plurality of distance information in different setting angles is obtained from the imaging of the spatial picture, i.e., from the spatial image, so that finally a 3D space image of the entire perceived setting is the result. In a preferred design of the method according to the invention, a plurality of distances R are determined at different setting angles for this reason and a 3D space image is created from the plurality of distances.

The method for determining distances according to the invention has substantial advantages compared to the method known from the prior art. For example, the method can be carried out using a very ordinary sensor, in the case of a light-sensitive sensor, for example, using a common image sensor e.g., in CCD- or CMOS technology. The image sensor used does not have to be designed in a certain manner, since spatial frequency filtering of the sensor elements of a voxel occurs solely using appropriate weighting of the sensor element signals, wherein this weighting can occur with a subsequent signal processing, which is either conducted algorithmically using one or more independent, sequentially-working data processors or for example, implemented using hardware; the method according to the invention is not dependent on the application of implementation. Spatial frequency filtering is very easy to implement and delivers the spatial image angular frequency of an object practically immediately, without the spatial image of the object having to be followed with complicated retrieval of correspondences by means of image analysis.

The measurements of the sensor elements of the sensor establish the smallest possible spatial period, with which spatial frequency filtering can be implemented, this corresponds to the extension of two sensor elements in the sensor direction to be evaluated. Depending on the variables of the sensor, any larger spatial periods of the spatial frequency filter can be implemented, which can make up total integer multiples of the measurement of the sensor elements and which simultaneously and, when applicable, adaptively can be used and evaluated for more exact determination of the spatial image angular speed.

The determination of distance is also not independent from external light sources of the object to be detected using the image capturing device with certain measuring signals, such as, for example, coherent light. In order to implement a spatial frequency filter, only the sensor element signals with their detected signal intensities have to be evaluated, here, it could be a case of, for example, a light-sensitive image sensor e.g., weakly mottled grays or even and stochastic textures caused by paving, grass, leaves, etc., which can lead to unsolvable correspondence difficulties in other image capturing devices. A further advantage of the method according to the invention is that it is not sensitive as far as movement of the image capturing device on its own; a relative velocity of the movement of the image capturing device to the object, whose distance is to be determined being more necessary for distance determination.

Furthermore, the invention is based on the knowledge that a rotation component of the movement of the image capturing device leads to no spatial image shift in the scope of the field of view, which contains location information. This can be comprehended when a rotation of the image capturing device is assumed around an axis of the main level of the picture generating element of the image capturing device. In this rotation movement, all elements of the space image are moved on the sensor regardless of their object distance (!) with the same angular speed caused by the rotation, the displayed objects due to change their relative position to one another in the spatial image. The above-described effect is also valid for all other rotational movements and the part of rotation of a mixed rotational-translational movement of the image capturing device.

According to a particularly advantageous design of the invention, it is provided for this reason that essentially only the translation components of the movement of the image capturing device are used to determine the spatial image angular speed and thus the object distance. This can be implemented, for example, in which the obtained rotational components of the movement of the image capturing device are compensated by stabilizing the image capturing device, wherein the image capturing device or components of the image capturing device are aligned opposite to the rotational movement so that the spatial image does not reproduce the rotational movement on the sensor, the spatial image, consequently, only displaying the translational movement. Another possibility exists in that the rotational components contained in the movement of the image capturing device do reach the sensor of the image capturing device, but is detected and subsequently eliminated.

Rotational compensation of the interfering actual rotation may be exemplified on an exception of parallel rotation: during level curve travel with a mounted image capturing device and a constant speed of vᵣₒₜ=4 m/s around e.g., a tree that is 40 m away as curve center, an incorrect angular speed ω_{meβ}=0 on the spatial image is measured despite the real rotation ωᵣₒₜ=−4 m/s/40 m=−0.10 rad/s (positive, when the tree is a mirror image with the same curve situation), because the displaying sensor element concerned is directed without rotary motion to the tree and thus the pseudo rotation caused by translation is completely compensated. The value ω_{meβ}−ωᵣₒₜ=0−(−4 m/s/40 m)=+0.10 rad/s first describes the correct value. More complex rotations only have to be taken into consideration with their vectorial portion in the sensor plane. When this portion ωᵣₒₜ parallel to the vector ω_{meβ} has been determined, the interfering rotation of the measuring period concerned can be compensated according to Equation 4 with consideration of the comments to the “cos α” term or “cos(α−β)” described in equations 2 and 3.

$$R = \frac{{v}_{tr} \cdot sin α}{( {ω}_{me β} - {ω}_{rot} )} \qquad Equation 4$$

In a further advantageous design of the invention, the spatial image angular speed is determined in more than one sensor direction, so that the image of an arbitrary movement of the image capturing device can be completely detected, since in the general case, the spatial image of the object on the sensor crosses the sensor not only in one sensor direction, but spatially distributed in multiple sensor directions. In determining spatial image angular speeds in more than one sensor direction, the spatial image angular speeds containing voxels are vectorially added to a total spatial image angular speed and the obtained total spatial image angular speed forms the basis for determining the object distance, so that correct distance information of the object and the projection of the direction of movement are obtained. In this context, a further preferred design of the invention provides that the balance points of the voxel formed in different sensor directions for calculating the object distance for a certain part of the space lie close together, in particular are essentially identical. This has the advantage, that the different added spatial image angular speeds in all evaluated sensor directions actually belong to the same space direction and thus, to the same detected object.

The complete trajectory of the object results at a known relative velocity vₜᵣ from the measurement of the three-dimensional object positions.

In a preferred design of the method according to the invention, the weighting of the sensor element signals of the sensor elements of a voxel in a sensor direction in a spatial frequency filter phase is chosen so that a good as possible sine approximation is implemented, so that a certain harmonic portion of the spatial image can be extract as well as possible. In the choice of the weighting of the sensor element signals of the sensor elements, in particular the geometry of the sensor elements involved is taken into consideration, since the geometry of the sensor elements equally influences the functionality of the obtained spatial frequency filter. This is in particular of importance when the form of the sensor elements deviates from the—usual, at least for a light-sensitive sensor—rectangular form.

In a further, preferred embodiment of the invention having the above-mentioned characteristics, the sine approximations of the weighting of the sensor element signals in at least two spatial frequency filter phases in a sensor direction are chosen to be relative to one another so that the spatial frequency filter phases are about essentially a quarter of a spatial period phase-shifted to one another. This measure achieves that both obtained, corresponding spatial frequency filter components are orthogonal to one another and quasi span an orthogonal coordinate system for the indicator of the spatial image phase. The spatial frequency filter components behave, in this case, like in-phase and quadrate components of corresponding I/Q analysis systems known from telecommunications from the time frequency field.

The indicator describing the output signal of the spatial frequency filter and thus the spatial image phase are completely described by the spatial frequency filter components corresponding with the two spatial frequency phases to be evaluated, regardless of whether the spatial frequency filter phases represent the approximation of a harmonic oscillation and the spatial frequency filter phases are orthogonal relative to one another. The amount—i.e., the length—of the indicator of the spatial frequency filter output signal allows for an assessment of the underlying signal quality, wherein signals with too small amplitudes can be discarded.

In a particularly advantageous design of the invention, spatial frequency filtering is carried out in at least one sensor direction in different spatial frequency filter phases, in that at least one sensor element is assigned to one voxel—regardless of the spatial frequency filter phase to be evaluated—and the sensor is shifted in and/or against the one sensor direction corresponding to the spatial frequency filter components to be achieved in the respective spatial frequency filter phase, so that a sensor shift is implemented. In the application of the method, a spatial frequency filter in one phase can consist of, e.g., two adjacent sensor elements in the chosen sensor direction, whose sensor elements, for example, are weighted with different algebraic signs. The same voxel consisting of the same adjacent sensor elements allows spatial frequency filtering of the same spatial image in another spatial frequency filter phase, in that the sensor is shifted in the chosen sensor direction, for example along the length of a half sensor element or along the length of a quarter of a spatial period, which leads to the implementation of a 90° shift, in practice, e.g., using a piezo element operated by an actuator. In the method designed in this manner, both of the spatial frequency filter components can only be determined successively in the different spatial frequency filter phases. Thus, it is preferable that to carry out the shift of the sensor as quickly as possible after determining the first spatial frequency filter component in the first spatial frequency filter phase, so that both different spatial frequency filter phases in the chosen sensor direction are determined as close in time to another as possible, so that the space image is only subjected to a small as possible change of location in the interval.

According to a further preferred design of the invention, with which the above described design can also be combined, spatial frequency filtering is carried out in at least one sensor direction in different spatial frequency filter phases, in that at least one sensor element is assigned to one voxel—regardless of the spatial frequency filter phase to be evaluated—and the spatial image is shifted in and/or against the one sensor direction corresponding to the spatial frequency filter components A₀, A₉₀ to be achieved in the respective spatial frequency filter phase, which leads to the implementation of a spatial image shift. This spatial image shift is achieved in particular using a change of position of the picture generating element, which only requires very small deflections of the picture generating element; this can only be a change of position of a part of the picture generating element, for example the deflection of a prism, which can be a component of the picture generating element. For the evaluation of the sensor element signals essentially the same is valid for a spatial image shift as was also described above for the sensor shift.

When it is said that presently a method for determining the distance of at least one object found in a space to a image capturing device having a picture generating element and a sensor is being discussed, then this may initially imply the notion that only optical image capturing devices were considered here. In reality, the method according to the invention is neither limited to an application with an “ordinary” image capturing device in the visual range of light nor to an application with any image capturing device that is limited to the detection of electromagnetic radiation. More so, the method described here can be applied to a plurality of signals, coming from objects found in a space, i.e., for example, are reflected from these objects. Here, as an analogy to daylight being reflected from objects, there could also be sound waves reflected by objects, which are transported through a gaseous or liquid medium. The method according to the invention depends essentially not on the type of image capturing device and the type of obtained sensor element signals, as long as the sensor consists of multiple sensor elements arranged essentially flat next to one another and the picture generating element displays at least one portion of the space on the sensor and a section of the space detected by the image capturing device at a certain setting angle is displayed on a certain sensor element and created by sensor signals—of any type—corresponding to the sensor elements.

According to another particularly preferred design of the method according to the invention, spatial frequency filtering is carried out in at least one sensor direction in different spatial frequency filter phases, in that for each spatial frequency filter phase—at least partially—different sensor elements are assigned to a voxel—phase voxel—wherein the phase voxels created in this manner are opposingly spatially shifted in the sensor direction to be evaluated, which finally leads to the implementation of a voxel shift. The method according to this embodiment has the advantage that only one single point in time is required from the spatial image detected by the sensor; only—insofar as the phase voxels at least partially use the same sensor elements—the sensor element signals of certain sensor elements have to be multiply evaluated or weighted in order to make spatial frequency filtering possible in both spatial frequency filter phases. All in all, very high sampling rates of the spatial frequency filter can be achieved using this method.

In an extreme case, the phase voxels, i.e., the voxels that allow spatial frequency filtering in different spatial frequency filter phases, do not have any common sensor elements, so that in order to detect different spatial frequency filter phases, not even a voxel shift is required. Even, in this case, if there are no sensor elements that are required for evaluating one as well as the other spatial frequency phase, this is a special case of the described method of voxel shifting, even if, in this case voxel shifting is no longer required.

According to a further preferred design of the invention, not only are the weighted sensor element signals of the respective voxel—central voxel—defining the spatial period used in determining the spatial frequency filter components of the spatial frequency filter phases of a voxel in one sensor direction, but additionally, also the sensor signals of at least one repetition of the central voxel—auxiliary voxel—lying in the sensor direction to be evaluated, so that the central voxel and the auxiliary voxel define a voxel row, wherein, in particular the corresponding sensor signals of the central voxel and the auxiliary voxel are added together. The central voxel preferably forms the center of a voxel row. It is of particular advantage in this context, when the sensor signals of the auxiliary voxels are weighted less than the corresponding sensor signals of the central voxel, namely in particular are decreasingly weighted with increasing distance from the central voxel, in particular according to a bell-shaped weighting curve, preferably according to a harmonic weighting curve, preferably according to a weighting curve without a constant component. A Gaussian curve, for example, is suitable as weighting curve. Using this measure, it is guaranteed that harmonics and noise are essentially inhibited and that the spatial image migrating from the central voxel is still detected and can still be detected for continuous detection of the spatial image angular speed, so that a certain continuity is guaranteed in the detection of spatial image phases and thus the spatial image angular speed.

It follows from the designs of the method according to the invention described in general, in particular from the geometric and kinematic features of the method according to the invention, that the relative velocity of the image capturing device—here in particular the translational components of movement—have direct influence on the determined object distance. In this respect, it is evident that a static setting of objects can be easily detected without ado with the method according to the invention, but that irregularities result when the objects found in the range of detection of the image capturing device have an—unknown—movement on their own accord.

According to a particularly preferred and advantageous design of the invention, the distance of an object to the image capturing device determined at a first point in time at a certain setting angle is used for predicting future distances of objects at future setting angles, assuming static objects—not moving on their own—and acknowledging the relative velocity of the movement of the image detecting device. In order to understand the design of the invention, it is important to visualize that the course detected by the image capturing device of a static object at a known relative velocity of the movement of the image capturing device to this object can be determined at any point in time, as soon as the position of the object—object distance and setting angle—is known at a certain point in time. When the object is static, i.e., cannot move on its own, the position of this object can be largely deterministically predicted for every future point in time, insofar as the term “prediction” in the application used here does not have an incalculable component, which cannot be predicted. An object that is able to move on its own can be determined based on the predictability in the scope of measurement accuracy of the position of a previously detected—static—object, in that at a certain point in time, the estimated object positions are compared to the object distance actually detected at this point by measurement, wherein deviating object distances at a certain setting angle indicate an object that can move on its own and wherein the variables of this comparison of such adjacent objects that can move on their own and are static, the objects that can move on their own are assessable in their position and movement.

Furthermore, the invention relates to a device for determining the distance of at least one object found in a space, having a picture generating element, a sensor and a signal processing unit, wherein the sensor consists of multiple sensor elements—voxel—arranged essentially flat next to one another, the picture generating element is able to display at least a part of the space on the sensor—spatial image—wherein a part of the space captured by the picture generating element at a certain setting angle can be displayed on a certain sensor element and can be generated by a sensor element signal corresponding to the sensor element, wherein the signal processing unit is designed so that it can carry out a method as described above.

In detail, there are a number of possibilities for designing and further developing the method and device according to the invention. In this respect, reference is made to the following detailed description of preferred embodiments in connection with the accompanying drawings.

### BRIEF DESCRIPTION OF THE DRAWINGS

FIG. 1 is a representation of the fundamental geometric and kinematic correlations,

FIGS. 2a & 2b are visual representations of distance determinations according to the equation of rotational movement in the geographic coordinate system and unit sphere coordinate system in the same image as well as a corresponding example,

FIGS. 3(a) & 3(c) are representations of a sensor with sensor elements and FIGS. 3(b) & 3(d) are representations of a corresponding spatial frequency filter phases achieved by spatial image shifting,

FIGS. 4(a) & 4(b) show a sensor with rectangular sensor elements and spatial frequency filter phases achieved by voxel shifting,

FIGS. 5(a) & 5(b) each show a sensor with rectangular sensor elements and a spatial frequency filter implemented in the diagonal direction of the sensor, and FIGS. 5(c) & 5(d) show sine approximations according to the weights of FIGS. 5(b) & 5(a), respectively,

FIG. 6 shows a sensor with hexagonal sensor elements—hexels—two-rowed voxel and evaluation in two sensor directions,

FIG. 7 shows a sensor with hexagonal sensor elements—hexels—two- and three-rowed voxel and evaluation in three sensor directions,

FIG. 8 shows a sensor with—hexels—and three-rowed, symmetrical voxel,

FIG. 9 shows a sensor with—hexels—and three-rowed, symmetrical voxel, with complete voxel density for the evaluation,

FIG. 10 shows a sensor with—hexels—and three-rowed, symmetrical voxel, with 25% voxel density for the evaluation,

FIG. 11 shows a sensor with—hexels—and three-rowed, symmetrical voxel, with 11.5% voxel density for the evaluation,

FIG. 12 shows a sensor with—hexels—and three-rowed, symmetrical voxel, with 6.25% voxel density for the evaluation,

FIG. 13 shows a sensor with rectangular sensor elements and three-rowed, symmetrical voxel.

### DETAILED DESCRIPTION OF THE INVENTION

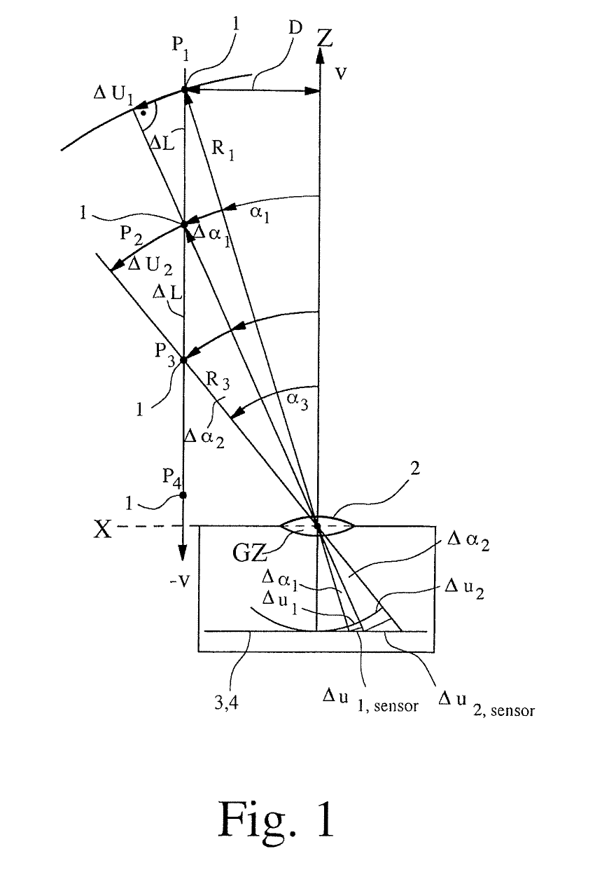

In FIG. 1, the geometric and kinematic conditions are initially shown, that are necessary for understanding the method described here for determining the distance R of at least one object 1 found in a space to an image capturing device (not shown in detail) having a picture generating element 2 and a sensor 3, wherein the sensor 3 is formed of multiple sensor elements 4 arranged essentially flat next to one another. The picture generating element 2—in the present embodiment a lens—displays at least a part of the space on the sensor 3, wherein this image is called spatial image in the following. Here, a part of the space captured by the picture generating element 2 at a certain setting angle α is displayed on a certain sensor element 4 and is generated by a sensor element signal corresponding to the sensor element 4.

According to the mathematical correlations given above in equations 1 to 4, the relative velocity v of the movement of the image capturing device to the object 1 is determined, wherein “determination” can also mean that the relative velocity v of the movement of the image capturing device is provided and, thus, known. In FIG. 1, a situation is shown that the image capturing device moves straight with a constant relative velocity v. As a result, the object 1 found in the space approaches the image capturing device in the course of its movement and, thus, the shown picture generating device 2 and the sensor 3, wherein the greatest proximity of the object 1 is reached when it has reached the position perpendicular to the straight movement trajectory of the image capturing device.

In FIG. 1, there are three positions P₁, P₂ and P₃ shown that the object 1 takes at three successive, equidistant points in time. With the help of FIG. 1, it is easy to imagine that practically all of the objects 1 removed “infinitely far” from the image capturing device are detected at a setting angle α approaching zero. A determination of a distance is practically not possible under these conditions. The object 1 successively takes the position P₁ with a distance R₁ at a setting angle α₁, the position P₂ with a distance R₂ at a setting angle α₂ and finally a position P₃ with a distance R₃ at a setting angle α₃. The corresponding distances P̅₁̅P̅₂̅, P̅₂̅P̅₃̅ and P̅₃̅P̅₄̅ are excessive for reasons dealing with technical drawing and practically only amount to a fraction of the length of the radius vectors.

It can be observed that the setting angle α changes increasingly with increasing approach of the object 1 to the image capturing device or to the picture generating element 2 of the image capturing device, i.e., the angular speed increases, with which the radius vector \vec{R} crosses the setting angle α₁, α₂ and α₃. The closer an object 1 lies to the image capturing device and the smaller the distance R is, with which an object passes the capturing device, the higher the angular speed is, with which the object 1 passes by the image capturing device. The correlations also result from the mathematical correlations according to the equations 1 to 4. The method described and shown here is based on these known correlations.

The position P₄ was no longer taken into consideration in FIG. 1, because it evidently no longer lies in the image capturing range of the picture generating element 2.

An important advantage of the method lies in the freedom of the alignment of the image capturing device. This only has to be turned 90° in the corresponding direction for detection of the close-up in position P4. For this reason, the distortions are minimized using projection on a low-cost level sensor and the measuring accuracy of the target angular speed ωₒᵣₜ=ωₘₑₛ is increased at the same time. A further great advantage is made evident; in place of rotation, image capturing devices can be operated parallel to the expansion of the image capturing range without any additional effort.

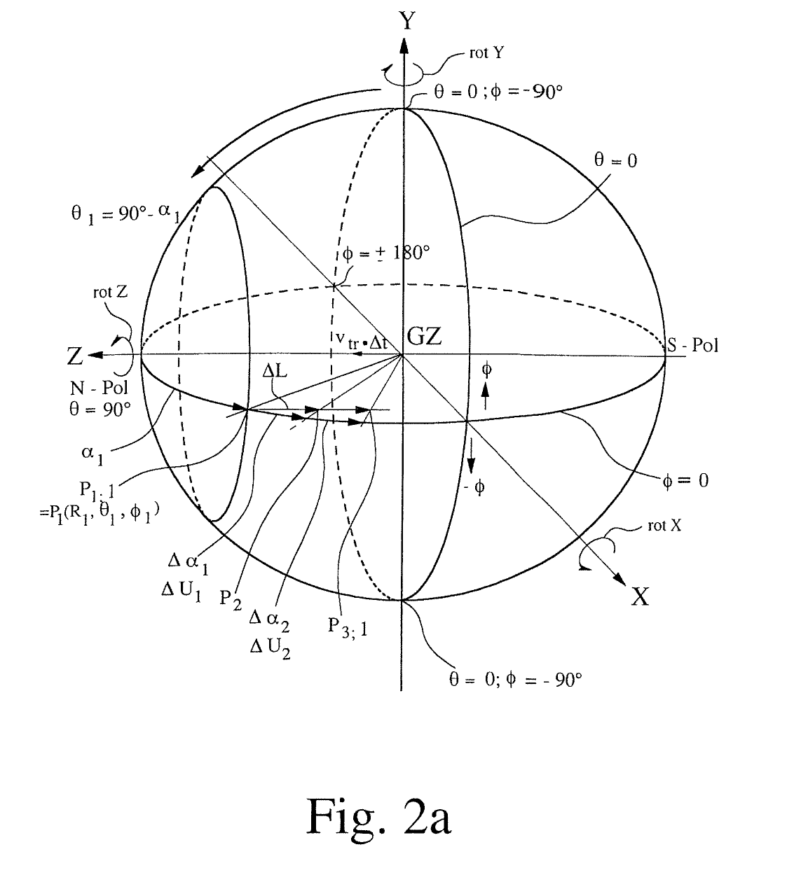

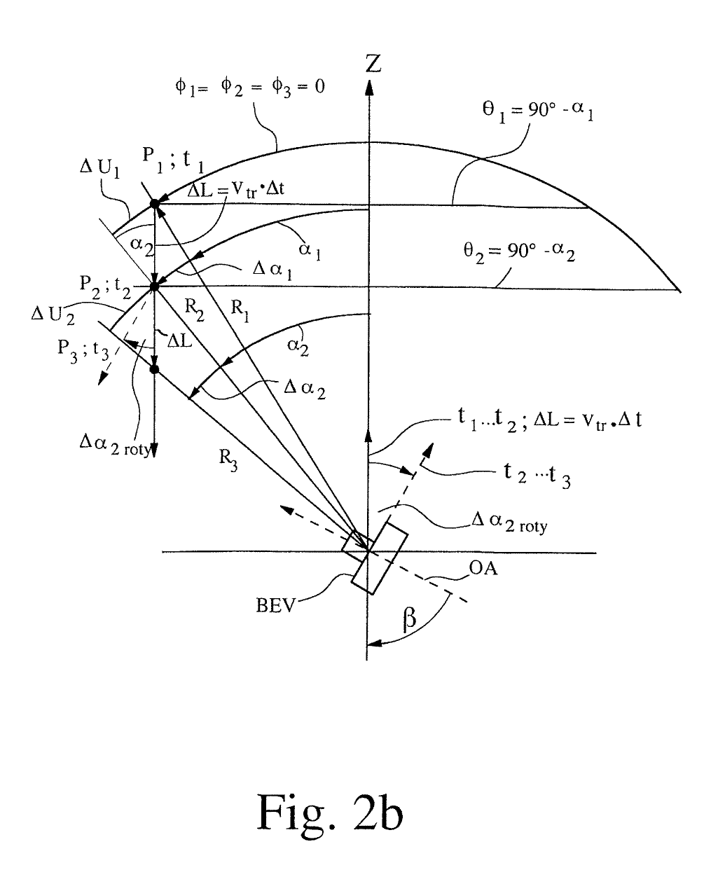

The general method, in particular represented and described with the help of FIGS. 1, 2a and 2b for determining the distance R of at least one object 1 found in a space to an image capturing device is characterized in that the relative velocity v of the movement of the image capturing device to the object 1 is determined, that by evaluating the sensor element signals of at least two sensor elements 4—voxel 5—a spatial image angular speed ω_{mes,sensor} is determined and the object distance R is determined using the relative velocity v of the image capturing device, the orthogonal object angular speed ωₘₑₛ attained from the spatial image angular speed of the object 1 displayed on the sensor elements 4 and the setting angle α of the object 1. The correlations forming the basis of the general method have already been explained in detail in the general part of the description, wherein the general part of the description can be applied without limitations directly to FIGS. 1, 2a and 2b due to the used formula signals.

It was described in the introduction that the method applied for determining the spatial image angular speed ω_{mes,sensor} on the sensor element is basically arbitrary and that general methods for dynamic determination of distances are not limited to a special method. The determination of the spatial image angular speed ω_{mes,sensor} in the embodiments shown is implemented using an adept design of spatial frequency filters.

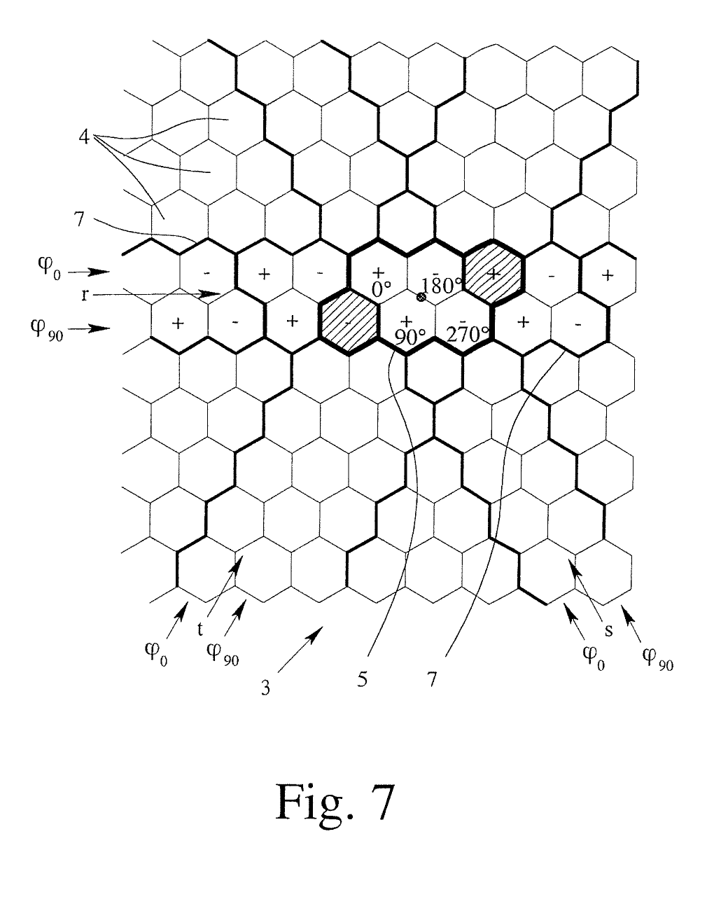

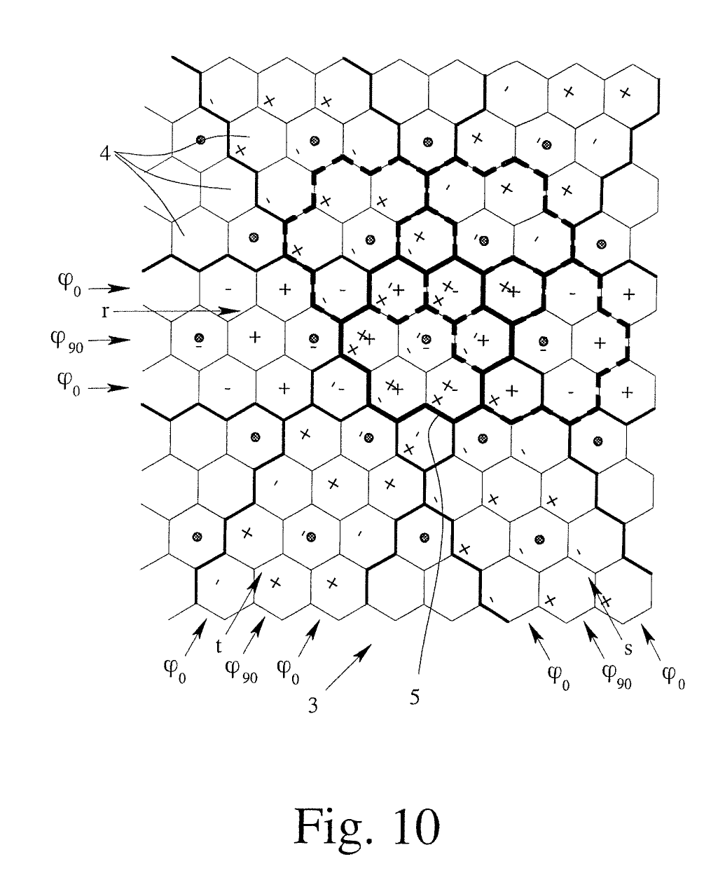

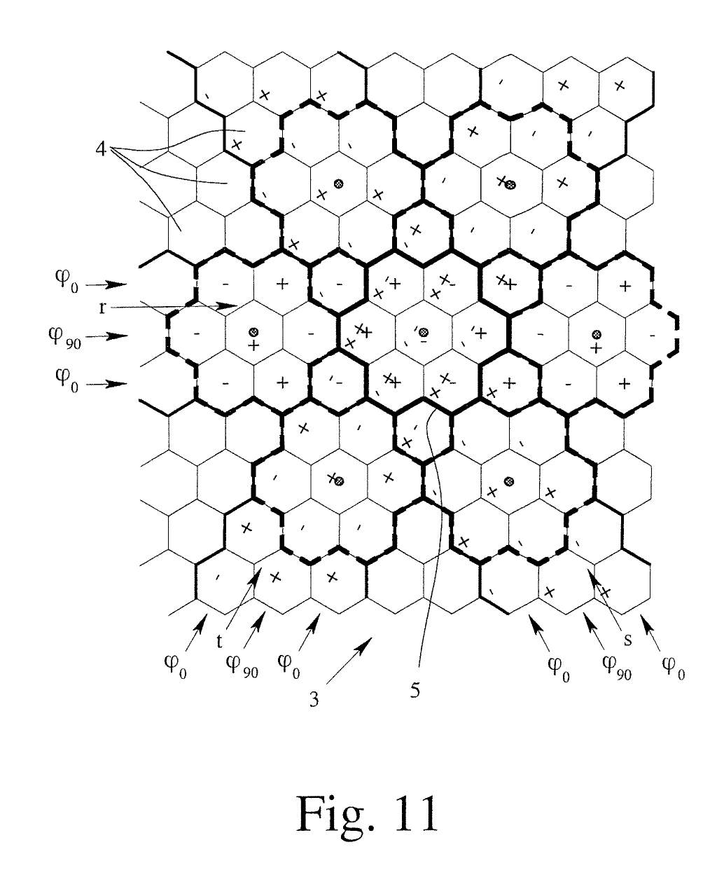

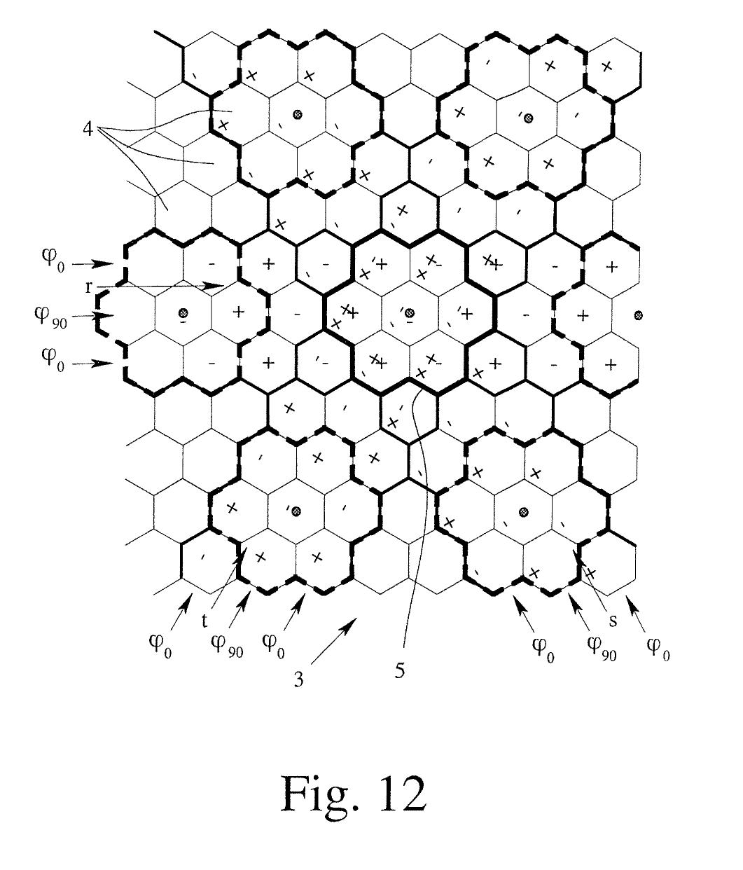

The embodiments shown in FIGS. 1 to 13 have in common that the spatial image angular speed ω_{mes,sensor} is determined by forming a spatial frequency filter using appropriate weighting of the sensor element signals of at least two sensor elements 4—which form in total one voxel 5—in at least one sensor direction x, y, r, s, t, wherein the spatial frequency filter subjects at least the sensor element signals of the voxel 5 to spatial frequency filtering in at least two different spatial frequency filter phases φ₀, φ₉₀ and a spatial image phase φ of the voxel 5 is determined from the obtained corresponding spatial frequency filter components A₀, A₉₀, that at least two spatial image phases φ of the voxel 5 are determined by means of temporal signal sampling of the spatial frequency filter and the spatial image angular speed ω_{mes,sensor} is determined from the temporally spaced spatial image phases φ.

It can be seen with the help of FIG. 1 that the movement components perpendicular to the distance vectors R₁, R₂ and R₃ are detected by the sensor 3 and can be perceived by the sensor 3 as spatial image angular speed ω_{mes,sensor}. In a flat sensor 3 as shown in FIG. 1, the image of the space is distorted at an increasing setting angle α, shown unrealistically here with too large of an angle to the optical axis; a situation that can make allowance using multiplication of the distance R determined according to equation (1)—in particular in the case of a non-calibrated object lens—by dividing the result by cos α, as is shown in equation (2). The detected spatial image angular speed called ω_{mes,sensor} in the equation or the object angular speed ωₘₑₛ determined using this are based on translational movement of the image capturing device in the ideal case.

As is described above, the speeds of the spatial image caused by rotation of the image capturing device do not contain distance information, since the shifts—or more exactly, rotations—of the spatial image are independent of the distance so that the relation of the objects to one another does not change in the spatial image. For this reason, all methods shown in FIGS. 1 to 13 for determining the spatial image angular speed ω_{mes,sensor} and thus the object distance R use essentially only the translational components of movement, in particular in that contained rotation components ωᵣₒₜ of the movement of image capturing device are compensated by stabilizing the image capturing device. In other methods—not shown here—contained rotational components ωᵣₒₜ of the movement of the image capturing device are detected by a sensor 3, but are subsequently eliminated in image processing.

FIG. 2a, 2b should exemplify the relatively complex correlations, which form the basis of the three-dimensional object distance determination according to the invention with the help of only a two-dimensional image capturing device. Difficulties in this sense are, in particular, the apparent low quality of the information available for determining the object distance—no length information—, also the freedom of movement of the image capturing device in space, which, in addition to information about its trajectory and its translational velocity vₜᵣ e.g., in the world coordinate system of the objects, only receives angle information concerning unknown object positions, the setting angle α from its own direction of movement to the unknown object and its temporal derivation.

Since concrete lengths are not initially available, a coordinate system is introduced in FIG. 2a to aid in understanding, the geographical coordinate system with the usual latitudinal and longitudinal circles, first as unit sphere coordinate system P(R, θ, Φ) with the radius R=1. The task of object distance determination shown in FIG. 1 is applied here to the globe coordinate system. The image capturing device is always found in a start position in the center of the globe coordinate system or in the geographical center GZ. It points randomly but purposively in the direction of the Z axis.

The object in an arbitrary unknown position P₁ is purposively placed on a longitudinal circle, here at the latitude Φ=0, the zero meridian and on an arbitrary latitudinal circle θ₁=90°−α₁. Thus, the object is positioned at position P₁(R₁=0, θ₁, Φ₁=0). This corresponds to the position p₁(x, y) on the adopted Cartesian sensor plane, which on a small scale agrees isogonically with the right angled latitudinal and longitudinal circles near P₁. For determining its position in space, the image capturing device moves in the current measuring period, here as sampling period Δt from t₁ to t₂ with its given linear velocity vₜᵣ from the geographical center GZ on the Z axis up to Z=ΔL=vₜᵣ·Δt. This step is arithmetically equal to relative movement of the object from position P₁ to position P₂ as is shown similarly in FIG. 2a.

The variables relevant for the determination of the object distance such as Δα₁, Δu₁, α₁ etc. are listed here as well as in FIG. 1 and are evaluated in the same manner according to the derived equation 5 in respect to the length of the distance vector R1. This process occurs simultaneously for many objects in the image capturing range of the image capturing device. Since this is only able to measure angles and angular speeds, it cannot differentiate between superimposed causes, here, on the one hand, the use of the change of angle created using translational movement vₜᵣ and, on the other hand, using the physical rotation of the image capturing device e.g., its rotational movement around the X-, Y-, or Z axis. They are caused e.g., by irregularities in the street and by ascents and curves for image capturing devices mounted to automobiles. Counter measures are explained in detail elsewhere. As long as these physical rotations occur and are not orthogonal to ωₘₑₛ as the basis of distance determination, they distort the results and their influence has to be prevented at all costs. They have to be specially designed for autonomous guiding of automobile anyway, in order to track the changes in a step for step navigation of the so-called camera coordinate system of the image capturing device in the world coordinate system of the object surroundings.

This process is described as an example with the help of FIG. 2b. FIG. 2b, which shows a largely agreeing situation of a distance determination according to the invention using relative movement of the image capturing device in a three-dimensional object space, shown in respect to the XZ plane, equal to the longitudinal circle plane of the zero meridian, in which the relative movement from the object and the image capturing device proceed. Again, the Y axis is perpendicular on the paper plane. In this embodiment, the image capturing device is turned at an angle β compared to its axis of movement or Z axis. The measuring principle does not change thereby. When an almost ideal image of the angle e.g., with a spherically adapted sensor surface is used instead of the angle-distorting image of the level sensor 3—as is indicated in FIG. 1—the turn in the image capturing range has no effect on the measurement results. Using faceted combination of image capturing devices of this sort, ball-shaped image capturing systems can be formed that can detect in all directions. When using level sensors, the angle distortion described in FIG. 1 increasing with the distance from the optical axis and in equation 2 are to be taken into consideration.

A further characteristic to be described with the help of FIG. 2b is the optimal combination first of the physical rotation measurement of ωᵣₒₜ, which selectively measures only this rotation e.g., using a rotational speed sensor. Secondly, the pseudo rotation ωₘₑₛ that can only be determined section by section using translational movement as well as the physical rotation ωᵣₒₜ, i.e., their vectorial addition are detected with the rotation measurement according to the described principle of evaluation of the equation of circular motion, implemented here according to the invention in a method for three-dimensional determination of the object space. In this manner, both rotation forms are known, first for measuring the object distances and secondly for a continuous navigation, in which the translation ΔL measured per sampling period and the corresponding rotation ωᵣₒₜ that serve to track the so-called camera coordinate system of the image capturing device in the world coordinate system and simultaneously to restore the calculation of the object distances to the simple start situation again and again.

In order to increase the measurement accuracy of the object distances, the use of image stabilizing systems available nowadays is usually chosen for the field of picture generating elements 2, since large physical rotation disturbances can distort the object distance. In FIG. 2b, the influence of a physical rotation, which has occurred in the sampling period between t₁ and t₂, is exemplified. The translation ΔL of the image capturing device is supplemented in FIG. 2b by an additional, either given rotation or a rotation measured using a rotational speed sensor e.g., around the Y axis. Up to now, this was registered in respect to the object 1 and the camera—as described above—in the world coordinate system after the pure translation from t₁ to t₂, wherein it was reset after registration in the camera coordinate system. As shown, a rotation around the Y axis Δα_{2roty} is added in the next step of t₂ to t₃ for translation ΔL, which is also mathematically and, if necessary, mechanically—using compensation in the image stabilizing system of the picture generating element—reset in the camera coordinate system after registration in the world coordinate system. In this manner, the course of the relative trajectory of the image capturing device to the objects initially assumed to be static in the surroundings can be randomly changed and measured with respectively small rotations and translations.

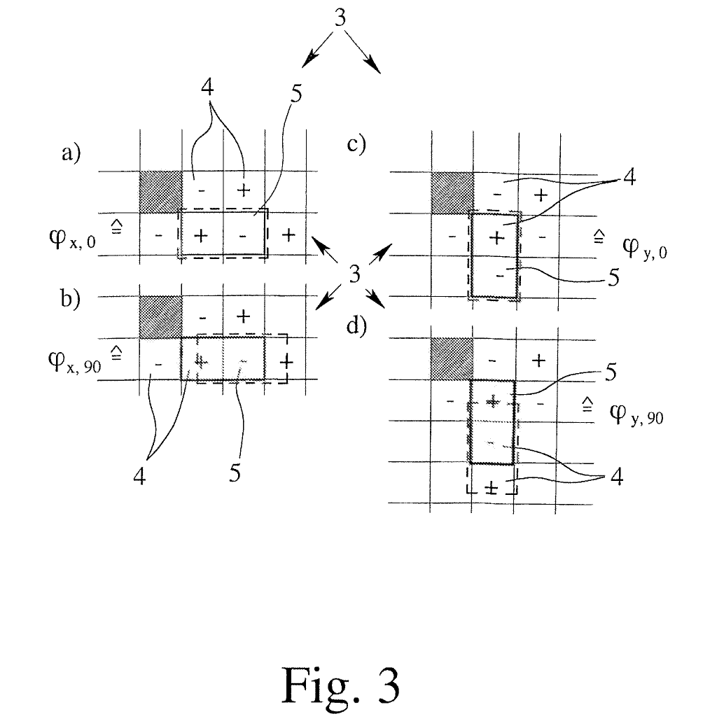

In FIGS. 3 to 6 and 13, the weighting of the sensor elements 4 is shown, with the help of which the spatial image detected by the sensor 3 can subjected to spatial frequency filtering; weighting is respectively characterized by a positive and a negative algebraic sign, wherein the sensor element signals, in the simplest case, are evaluated as such with these algebraic signs. By weighting the sensor element signals, a respective spatial frequency filter is implemented on the sensor 3 in a certain sensor direction, as was described in the general context and in respect to time frequency analysis.

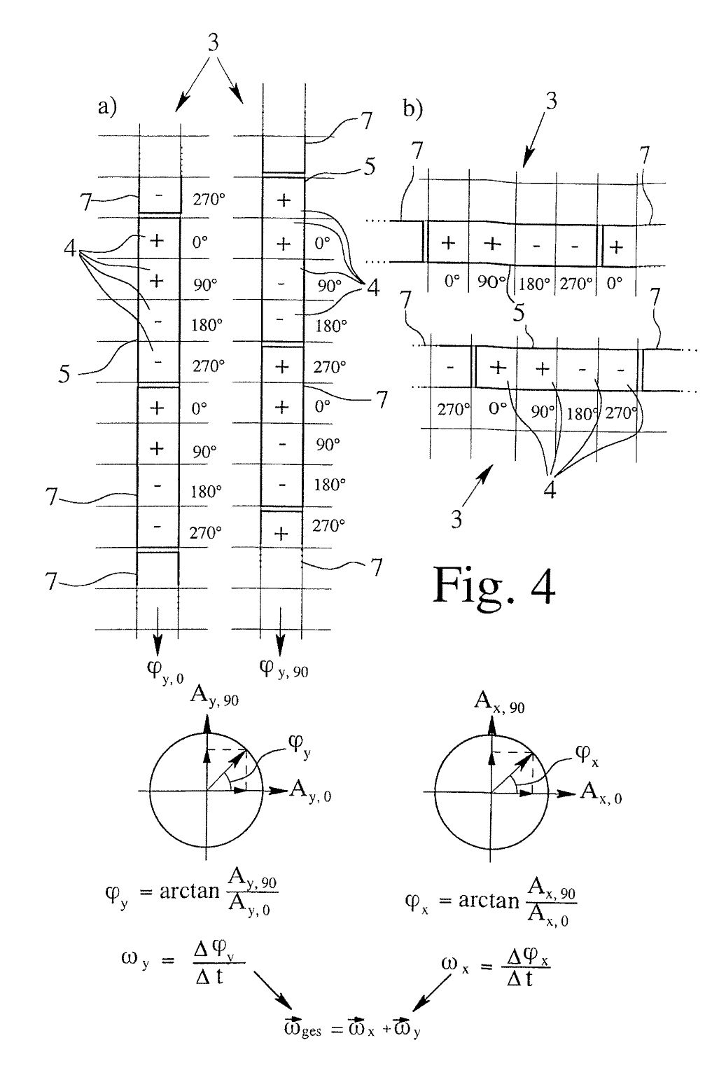

It is shown in FIG. 4 that spatial frequency filters are implemented in two different sensor directions on a Cartesian parquet sensor 3, namely in FIG. 4a in the “y-direction” and in FIG. 4b in the “x-direction”. It can be further seen that four adjacent sensor elements 4 were combined to a voxel 5, wherein the voxel 5 respectively sets a spatial period of the spatial frequency filter. With the help of the voxel, the corresponding spatial frequency filter components A_{x,0}, A_{x,90}, A_{y,0}, A_{y,90} are determined in each sensor direction in the spatial frequency filter phases φ₀, φ₉₀, which are shifted 90° to one another in the case shown. In FIG. 4 for identification of the sensor direction, both spatial frequency filter phases φ₀ and φ₉₀ are called φ_{x,0}, φ_{x,90} and φ_{y,0}, φ_{y,90}. The spatial frequency filter components A_{x,0}, A_{x,90}, A_{y,0} obtained in the sensor direction can be converted into corresponding spatial image phases φ using simple inverse trigonometric functions, which are called φₓ and φ_{y} in FIG. 4 for identification of the sensor direction.

Using temporal sampling of the spatial frequency filter, different spatial image phases can be obtained for each sensor direction at different times, wherein the spatial image angular speed ωₓ, ω_{y} for the respective sensor direction results from the change of the spatial image phases Δφₓ and Δφ_{y} and the sampling period Δt. In all of the shown methods, these obtained spatial image angular speeds ωₓ, ω_{y} are vectorially added to a total spatial image angular speed ω_{ges}, and this total spatial image angular speed ω_{ges} forms the basis for determining the object distance R.

In all of the shown embodiments of the method according to the invention, the weighting of sensor element signals of the sensor elements 4 of a voxel 5 in a sensor direction in a spatial frequency filter phase is chosen so that a good as possible sine approximation 6 is implemented, wherein the geometry of the sensor elements involved is also taken into consideration.

In FIGS. 3 to 5 and 13, Cartesian parquet sensors 3 are shown, wherein, in FIG. 3, a voxel consists of two adjacent sensor elements 4 and in FIG. 4, a voxel 5 consists of four adjacent sensor elements 4. The sine approximation 6 consists here, in that respectively half of the sensor elements 4 are weighted with one algebraic sign and the other half of the sensor elements 4 are weighted with the other algebraic sign; thus the sine approximation here is comparably crude, mainly the zero-crossings of a sine wave hit the mark. However, it has been seen that even such a sine approximation is sufficient for implementing a spatial frequency filter.

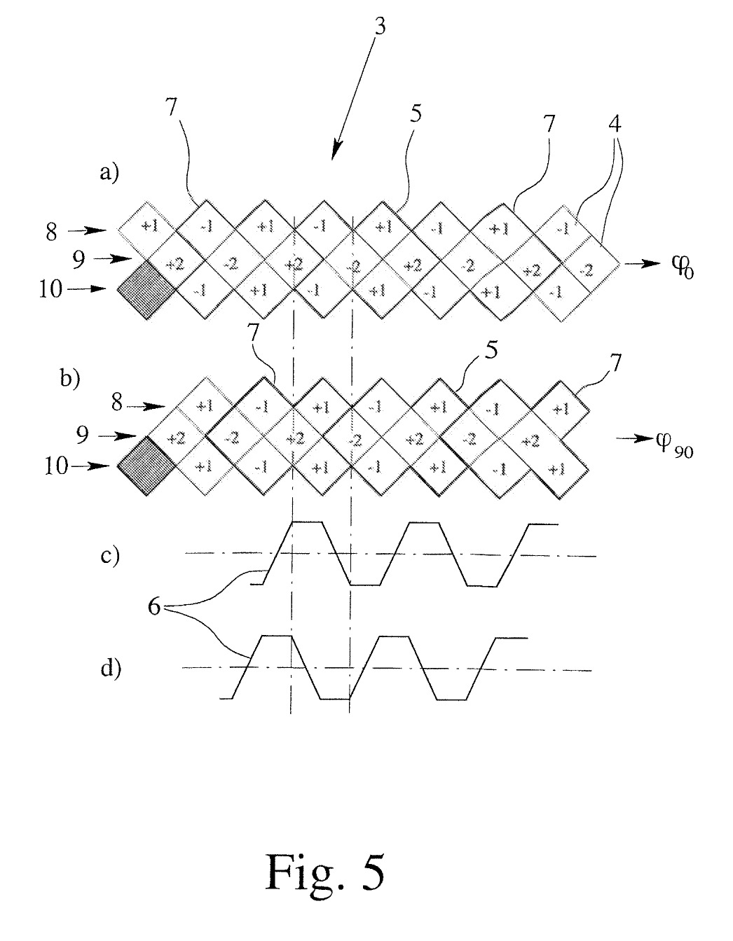

In the Cartesian parquet of the sensor 3 shown in FIG. 5, a much better sine approximation 6 has been achieved using a diagonal selection of the sensor 3 to be explained in more detail and using an adept design of the voxel 5, namely using sine curves approaching a trapezoidal curve course.

In all of the shown embodiments, the—shown only in FIG. 5—sine approximations 6 of the weighting of the sensor element signals in at least two spatial frequency filter phases in a sensor direction are chosen to be relative to one another so that the spatial frequency filter phases are about essentially a quarter of a spatial period phase-shifted to one another, so that the spatial frequency filter phases correspond essentially to in-phase and quadrate components of a I/Q analysis during determination of the spatial image phase X. The voxel in FIG. 4 correspond to the weighting curve 4d and the voxel in FIG. 5 correspond to the weighting curve 4c.

In FIG. 3 an embodiment of the method is shown in which spatial frequency filtering is carried out in at least one sensor direction in different spatial frequency filter phases—here called φ_{x,0}, φ_{x,90}, φ_{y,0}, and φ_{y,90}—, in that two sensor elements 4 are assigned to one voxel 5—regardless of the spatial frequency filter phase φ₀, φ₉₀ to be evaluated—the spatial image is shifted in and/or against the one sensor direction corresponding to the spatial frequency filter components to be achieved in the spatial frequency filter phases φ₀, φ₉₀, which is a spatial image shift. In the FIGS. 3a to 3d, one sensor element 4 is highlighted in dark in each of the shown sections of the sensor 3 in order to make clear that it is the same sensor element 4 in all views of the sensor 3. It can be easily seen in FIGS. 3a and 3b that the shown voxel is assigned to two sensor elements 4, although in FIG. 3a the spatial frequency filter phase φ_{x,0} is evaluated in the x-direction of the sensor 3 in FIG. 3a and in FIG. 3b the spatial frequency filter phase φ_{x,90} is evaluated in the x-extension of the sensor 3. In order to carry out a spatial frequency analysis in two phases on the basis of this non-changing weighting of the sensor element signals of the sensor elements 4 implied by the algebraic signs, the spatial image between FIGS. 3a and 3b is shifted half the length of a sensor element 4 to the right, which is indicated by the dashed box. Of course, the spatial image goes beyond the dashed section of the spatial image, the representation only serves to exemplify the spatial image shift. In order to be able to evaluate both spatial frequency filter phases φ₀, φ₉₀, the sensor 3, which is an image sensor using CMOS technology in the case shown, is actually exposed twice, once for each spatial frequency phase to be evaluated.

A similar situation is shown in FIGS. 3c and 3d for determining two spatial frequency filter components in the spatial frequency filter phases in the y-extension of the sensor 3, wherein, here, the spatial frequency filter phases φ_{y,0} and φ_{y,90} of the spatial image are determined. By applying the method of spatial image shift, in total, two spatial image phases in the x- and y-direction of the sensor 3 can be determined solely with one voxel with only four sensor elements 4, whereby a complete determination of the required spatial image angular speeds ωₓ and ω_{y}, is possible. The total spatial image angular speed ω_{ges} can be determined from these individual spatial image angular speeds ωₓ and ω_{y} perpendicular to one another, which then results in the object distance R of this object 1, which is displayed at an explicit setting angle α on the shown voxel 5.

In the FIGS. 4 to 6 and 13, different embodiments of a method for determining an object distance are shown, in which spatial frequency filtering is carried out in at least one sensor direction in different spatial frequency filter phases φ₀, φ₉₀, in that for each spatial frequency filter phase φ₀, φ₉₀—at least partially—different sensor elements 4 are assigned to a voxel 5—phase voxel—wherein the phase voxels created in this manner are opposingly spatially shifted—voxel shift—in the sensor direction to be evaluated.

In the embodiment according to FIG. 4, rectangular sensor elements 4 are used in turn, wherein the image of the space on the sensor 3 is fixed, i.e., can be influenced neither by a spatial image shift nor by a sensor shift. The movement of the spatial image on the sensor 3 occurs solely by the relative movement of the image capturing device to the displayed objects 1; the spatial image or a section of the spatial image is not shown in FIG. 4. In FIG. 4, one and the same section of the sensor 3 is shown twice, wherein the voxel 5 is aligned in the y-direction of the sensor 3 and thus provides the spatial frequency filter phases φ_{y,0} and φ_{y,90} in the y-direction of the sensor. It can be seen how the weighting of the sensor element signals of the sensor elements 4 is adapted dependent on the spatial frequency filter phase φ_{y,0} or φ_{y,90} to be evaluated. The voxel 5 shown consist each of four sensor elements 4, wherein each of the sensor elements 4 has a spatial period size of 90°. A phase shift of 90° is thus achieved by relative shifting of the weighting of the sensor element signals around a sensor element 4. In this method, as opposed to the method of spatial image shifting, a double exposure of the sensor 3 is not necessary, more so, it suffices to vary the weighting of the detected intensities of the sensor element signals of the sensor elements 4 according to the representation in FIG. 4, in order to arrive at the target evaluation of the spatial frequency filter phases φ_{y,0} and φ_{y,90}. The same situation is shown again in FIG. 4b for the evaluation of the spatial frequency filter phases φ_{x,0} and φ_{x,90} in the x-direction of the sensor 3.

A further, very advantageous embodiment of the invention is shown in FIG. 5, in which the sensor elements 4 of the sensor 3 are designed rectangular—in the case shown, square—and for an essentially orthogonal parquet of the sensor 3, wherein at least one first sensor direction x, y to be evaluated by spatial frequency filtering stretching diagonally to the square sensor elements 4 is chosen and each of six sensor elements 4 are combined to a three-rowed voxel 5 or phase voxel having each two sensor elements 4 in each row 8, 9, 10 of the voxel for evaluation in a spatial frequency filter phase φ₀, φ₉₀. The voxel rows 8, 9, 10 in both representations in FIGS. 5a and 5b correspond, in turn, to one and the same section of the sensor 3, wherein a sensor element 4 is shown in dark for better orientation. Sine approximations 6 are shown in FIGS. 5b and 5c, wherein the sine approximation according 6 to FIG. 5d arises from the weighting of the sensor element signals according to the upper representation in FIG. 5a and correspondingly, the sine approximation 6 in FIG. 5c arises from the weighting of the sensor element signals according to the representation in FIG. 5b.

In order to determine the first spatial frequency filter phase y₀, the sensor element signals of each of the two sensor elements 4 of the three rows 8, 9, 10 of the voxel are weighted with inverse algebraic signs, wherein the three sensor elements having each sensor element signals weighted with the same algebraic sign are arranged in the shape of an arrow pointing in the direction of the diagonal extension. In order to determine the second spatial frequency filter phase φ₉₀ while keeping the sensor elements 4 of the middle row 9 of the voxel, both sensor elements 4 of the upper row 8 and the lower row 9 of the voxel are arranged and their sensor element signals are weighted with an algebraic sign so that the three sensor elements 4 having each sensor element signals weighted with the same algebraic signal point in an arrow-like manner in the other direction of the diagonal extension. The total of four possible combinations here each detect phase levels shifted 90° to the respective spectral filter spatial frequency or filter spatial period determined by weighting and can be used in evaluation for error correction e.g., of asymmetries.

In the embodiment according to FIG. 5, the sensor element signals of the sensor elements 4 of the middle row 9 of the voxel are weighted according to amount essentially twice as heavily as the sensor element signals of the sensor elements 4 of the upper row 8 and the lower row 10 of the voxel. The sine approximations 6 according to FIG. 5 are achieved using these weightings, which represent a good approximation, in particular when it is taken into consideration that rectangular sensor elements 4 are used, as in the application in most of the standard image sensors. It is possible to use the same structure on the same sensor 3 also as Cartesian spatial frequency filter, however with the disadvantages of a larger Cartesian spatial period λₖ, =4p (4×pixel width) as opposed to the diagonal spatial frequency filter structure with λ_{d}=2√2·p, also with the worse rectangular sine approximation and the lower permeation of the weighting range for the inner 0° phase and the outer 90° phase.

In a further embodiment of the method according to FIG. 5 not shown in detail, it is provided that a second sensor direction to be evaluated is provided, which is oriented in the second orthogonal diagonal extension of the rectangular sensor elements 4. This can be implemented without ado, since only the right choice and weighting of the sensor elements and the sensor element signals corresponding thereto are of influence.

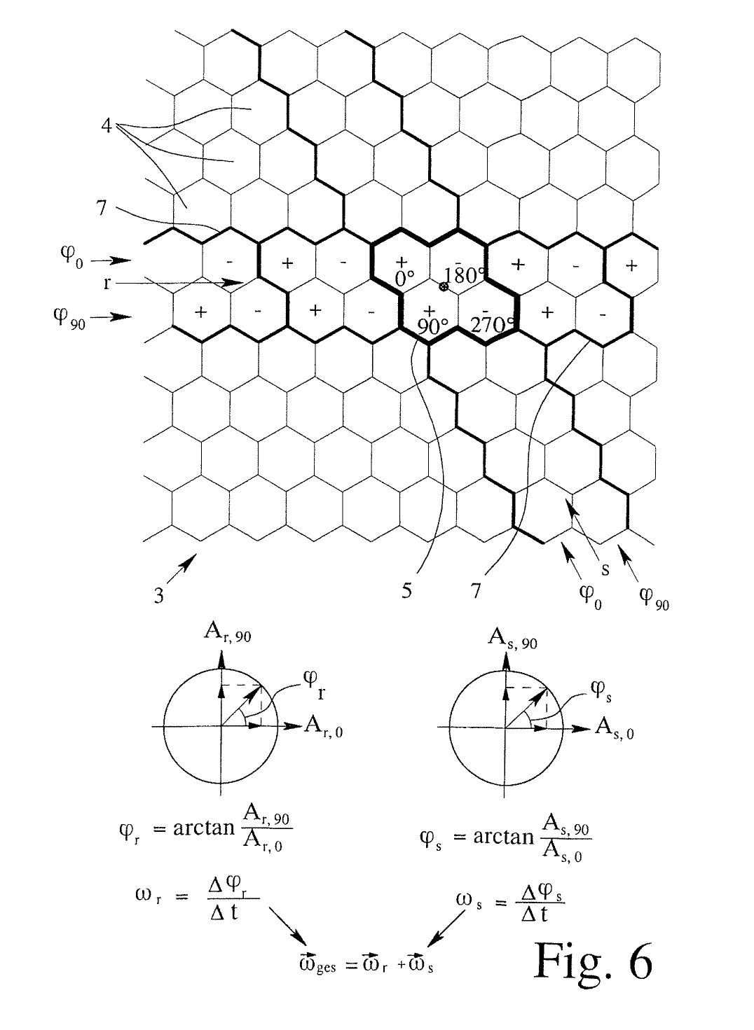

In the embodiment according to FIG. 6, the sensor elements 4 of the sensor 3 are designed hexagonally—they form a so-called hexel—so that the hexel form a hexagonal parquet of the sensor 3, wherein for each sensor direction r, s, t to be evaluated by spatial frequency filtering at least four hexel are combined to a two-rowed voxel 5, wherein the hexel adjacent to each other in a row of the voxel 5 form a spatial frequency filter for evaluation in a spatial frequency filter phase φ₀, φ₉₀ and in particular are weighted with different algebraic signs. This embodiment represents a special case of the embodiments according to FIGS. 4, 5 and 6, in which the different phase voxel have no common sensor element 4. For that reason, both spatial frequency filter phases φ₀ and φ₉₀ can be determined immediately with an evaluation in this embodiment. It is advantageous when the voxel 5 are subjected to spatial frequency filtering in at least two directions, wherein the sensor directions essentially form an angle of 60° or 120° due to the hexagonal parquet. In the shown embodiment according to FIG. 6, spatial frequency filtering is carried out in three directions, namely essentially in the directions 0°, 60° and 120°.

It is further shown in FIGS. 4 to 7 that not only the weighted sensor element signals of the respective voxel 5 defining the spatial period are used in determining the spatial frequency filter phases φ₀, φ₉₀ of a voxel 5 in one sensor direction, but additionally, also the sensor signals of at least one repetition of the central voxel 5, namely the auxiliary voxel 7, lying in the sensor direction to be evaluated, wherein, in particular the corresponding sensor signals of the central voxel 5 and the auxiliary voxel 7 are added together, which is not shown in detail here.

Also not shown in detail, but implemented in the shown embodiments is that the sensor signals of the auxiliary voxel 7 are weighted less than the corresponding sensor signals of the central voxel 5, namely are decreasingly weighted with increasing distance from the central voxel 5. In the shown embodiments, the sensor signals of the auxiliary voxel 7 are decreasingly weighted according to a Gaussian weighting curve.

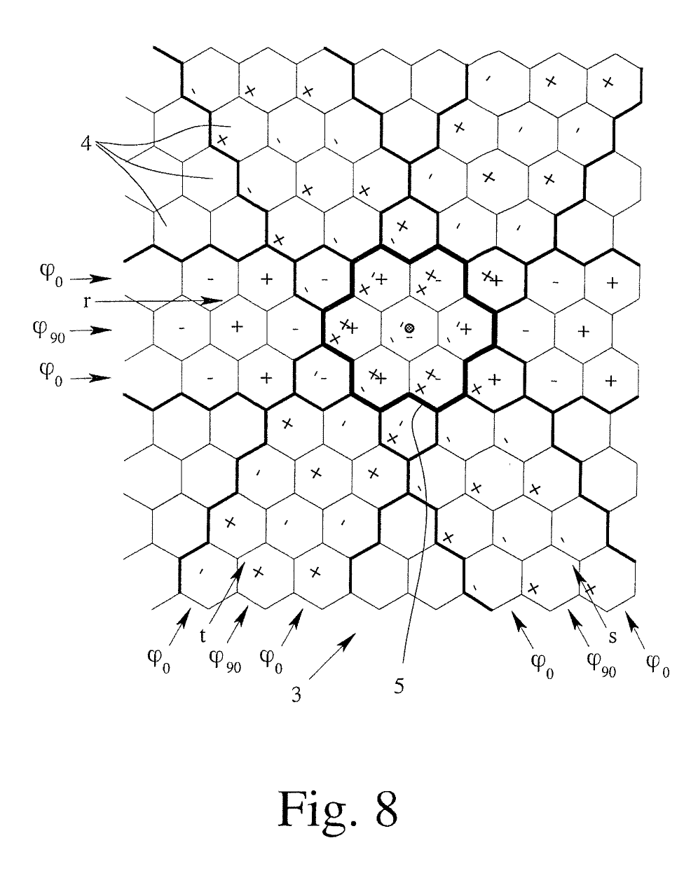

An embodiment is shown in FIG. 8, in which the sensor elements 4 of the sensor are designed hexagonally—hexel—and form a hexagonal parquet of the sensor 3, wherein for each sensor direction r, s, t to be evaluated by spatial frequency filtering at least four hexel are combined to a three-rowed voxel 5, wherein the hexel adjacent to each other in the middle row of the voxel 5 form a spatial frequency filter for evaluation in a spatial frequency filter phase φ₉₀ and the hexels adjacent each other in both outer rows of the voxel 5 form a spatial frequency filter for evaluation in another spatial frequency filter phase φ₀, wherein the corresponding sensor signals of the sensor elements 4 are weighted in particular with different algebraic signs. The total voxel in bold face is composed of the central voxel at the cross-point of voxel rows in the different sensor directions and is completely symmetrical in respect to the sensor directions, which is why the balance points of the voxel 5 are identical in different sensor directions.

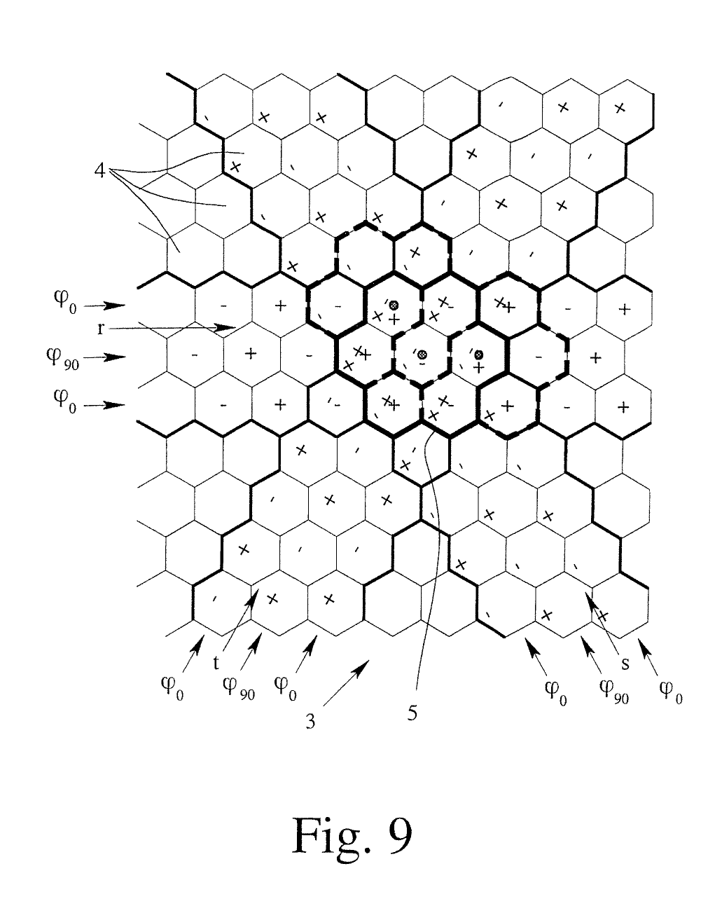

Hexagonal parquet of the type according to FIG. 8 is shown in FIGS. 9 to 12, wherein different density evaluations (distance overlap) are implemented in that the central voxel is arranged with different overlaps. Densities of distance determination are achieved of 100%, 25%, 11.1% and 6.25% with the evaluations according to FIGS. 9 to 12.

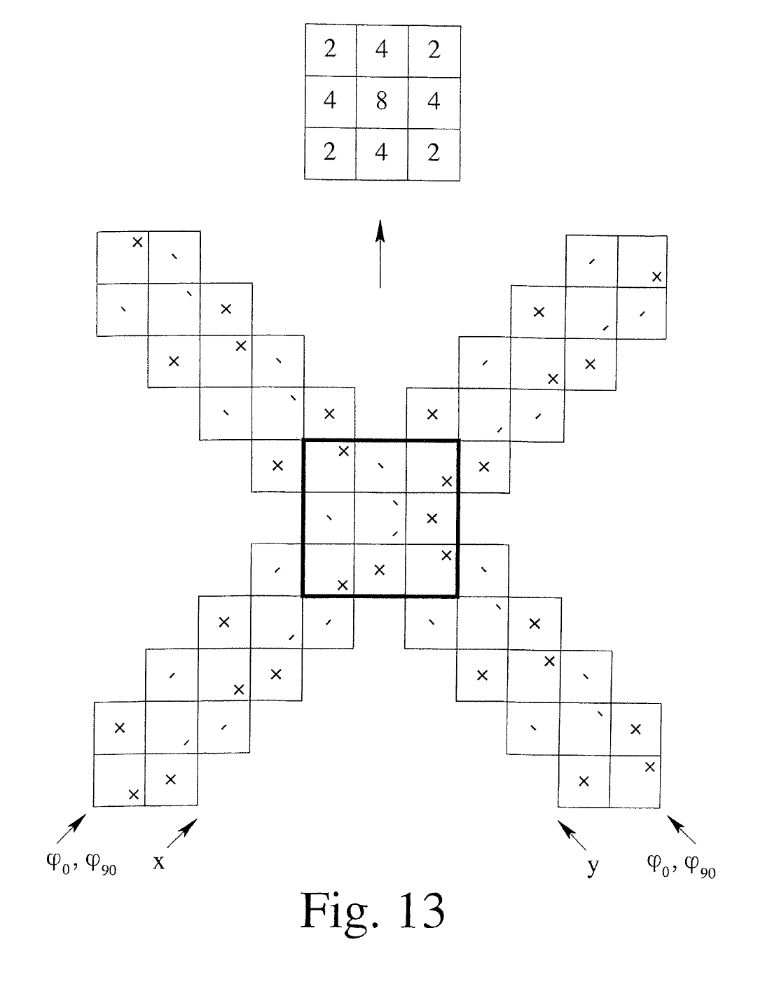

FIG. 13 shows an embodiment with square sensor elements 4 and a total voxel at the cross-point of the voxel rows with three times three sensor elements 4, whose sensor element signals are evaluated with the given weighting for the central voxel during selection.

1-21. (canceled)

22. Method for determining a distance of at least one object found in a space to an image capturing device having a picture generating element and a sensor, the sensor having multiple sensor elements arranged essentially flat next to one another, comprising the steps of:
displaying a spatial image of at least a part of the space on the sensor picture generating element,
displaying a part of the space captured by the picture generating element at a certain setting angle (α) on a certain sensor element, and
generating sensor element signals with the sensor elements,
determining the relative velocity (v) of the movement of the image capturing device relative to the object,
evaluating the sensor element signals of at least two sensor elements (voxel) to determine a spatial image angular speed (ω_{mes,sensor})
determining the object distance (R) using the relative velocity (v) of the image capturing device, an orthogonal object angular speed (ωₘₑₛ) attained from the spatial image angular speed of the object displayed on the sensor elements and a setting angle (α) of the object.

23. Method according to claim 22, wherein the spatial image angular speed (ω_{mes,sensor}) is determined by forming a spatial frequency filter using appropriate weighting of the sensor element signals of at least two sensor elements in at least one sensor direction, wherein the spatial frequency filter subjects at least the sensor element signals of the voxel to a spatial frequency filtering in at least two different spatial frequency filter phases (φ₀, φ₉₀) and a spatial image phase (φ) of the voxel is determined from the obtained corresponding spatial frequency filter components (A₀, A₉₀), wherein at least two spatial image phases (φ) of the voxel are determined by means of temporal signal sampling of the spatial frequency filter and the spatial image angular speed (ω_{mes,sensor}) is determined from the temporally spaced spatial image phases (ω).

24. Method according to claim 22, wherein in order to determine the spatial image angular speed (ω_{mes,sensor}) and thus the object distance (R), essentially only the translation component of the movement of the image capturing device is used, in particular in which rotation components (ωᵣₒₜ) contained in the movement of the image capturing device are compensated by stabilizing the image capturing device and/or rotation components (ωᵣₒₜ) contained in the movement of the image capturing device are detected and eliminated.

25. Method according to claim 22, spatial image angular speeds (ωₓ, ω_{y}) are determined in more than one sensor direction (x, y, r, s, t), the obtained spatial image angular speeds (ωₓ, ω_{y}) are vectorially added to a total spatial image angular speed (ω_{ges}) and the total spatial image angular speed (ω_{ges}) forms the basis for determining the object distance (R).

26. Method according to claim 22, wherein balance points of the voxels formed in different sensor directions (x, y, r, s, t) are used for calculating the object distance for a certain part of the space.

27. Method according to claim 22, wherein weighting of sensor element signals of the sensor elements of a voxel in a sensor direction (x, y, r, s, t) in a spatial frequency filter phase (φ₀, φ₉₀) is chosen in consideration of the geometry of the sensor elements so that as good as possible sine approximation of the weighting is obtained.

28. Method according to claim 27, wherein the sine approximation of the weighting of the sensor element signals in the at least two spatial frequency phases (φ₀, φ₉₀) in a sensor direction (x, y, r, s, t) are about a quarter of a spatial period phase-shifted relative to one another.

29. Method according to claim 22, wherein spatial frequency filtering is carried out in at least one sensor direction (x, y, r, s, t) in different spatial frequency filter phases (φ₀, φ₉₀), wherein at least one sensor element (4) is assigned to one voxel (5) regardless of the spatial frequency filter phase (φ₀, φ₉₀) to be evaluated and the sensor is shifted relative to sensor direction (x, y, r, s, t) corresponding to spatial frequency filter components (A₀, A₉₀) to be achieved in the respective spatial frequency filter phase (φ₀, φ₉₀), and wherein a spatial image shift is achieved on the sensor by changing the position of the picture generating element.

30. Method according to claim 22, wherein spatial frequency filtering is carried out in at least one sensor direction (x, y, r, s, t) in different spatial frequency filter phases (φ₀, (φ₉₀), wherein, for each spatial frequency filter phase (φ₀, φ₉₀), at least partially, different sensor elements are assigned to a phase voxel, and wherein the phase voxels created in this manner are oppositely spatially shifted in the sensor direction (x, y, r, s, t) to be evaluated.

31. Method according to claim 22, wherein weighted sensor element signals of a respective central voxel defining a spatial period used in determining spatial frequency filter components (A₀, A₉₀) of spatial frequency filter phases (φ₀, φ₉₀) of a voxel in a sensor direction (x, y, r, s, t), and sensor signals of at least one repetition of the central voxel lying in the sensor direction (x, y, r, s, t) to be evaluated are added together.

32. Method according to according to claim 31, wherein the sensor signals of the at least one repetition of the central voxel are weighted less than the corresponding sensor signals of the central voxel.

33. Method according to claim 23, wherein the sensor elements of the sensor are hexagonal and form a hexagonal parquet of the sensor, wherein, for each sensor direction (r, s, t) to be evaluated by spatial frequency filtering, at least four hexagonal sensor cells are combined to form a two-rowed voxel.

34. Method according to claim 23, wherein the sensor elements of the sensor hexagonal and form a hexagonal parquet of the sensor, wherein, for each sensor direction (r, s, t) to be evaluated by spatial frequency filtering, at least six hexagonal sensor cells are combined to faun a three-rowed voxel.

35. Method according to according to claim 33, wherein the voxel is subjected to spatial frequency filtering in at least two sensor directions (r, s), wherein the sensor directions (r, s) essentially form an angle of at least 120°.

36. Method according to claim 23, wherein the sensor elements of the sensor are rectangular and form an essentially orthogonal parquet of the sensors, wherein at least a first sensor direction (x, y) to be evaluated by spatial frequency filtering is selected that extends diagonally relative to the sensor elements and each of six sensor elements are combined to form a three-rowed voxel each of which has two sensor elements in each row of the voxel for evaluation in a spatial frequency filter phase (φ₀, φ₉₀).

37. Method according to according to claim 36, wherein, to determine the spatial frequency filter component (A₀) of a first spatial frequency filter phase (φ₀), the sensor element signals of each of two sensor elements of the three rows of the voxel are weighted with inverse algebraic signs, wherein each of the three sensor elements have sensor element signals weighted with the same algebraic sign are arranged in the shape of an arrow pointing in the direction of diagonal extension and wherein, to determine the spatial frequency component (A₉₀) of a second spatial frequency filter phase (φ₉₀) while keeping the sensor elements of a middle row of the voxels, the sensor elements of an upper row and a lower row of the voxels are arranged and their sensor element signals are weighted with an algebraic sign so that each of the three sensor elements have sensor element signals weighted with the same algebraic signal directed in an arrow-shaped manner in a second direction of diagonal extension.

38. Method according to according to claim 37, wherein the sensor element signals of the sensor elements of the middle row of the voxels are weighted according to an amount essentially twice as heavily as the sensor element signals of the sensor elements of the upper row and the lower row of the voxels.

39. Method according to claim 37, wherein a second sensor direction to be evaluated is provided that is oriented in the second direction of diagonal extension of the rectangular sensor elements.

40. Method according to claim 22, wherein the distance of an object relative to the image capturing device is determined at a first point in time at a certain setting angle (α) is used for predicting future distances of objects (1) at future setting angles (α), assuming statically positioned objects and acknowledging the relative velocity (v) of the movement of the image detecting device, wherein the predicted future distances and associated setting angles (α) of the object are used for identifying the objects.

41. Method according to claim 22, wherein a plurality of object distances (R) are determined at different setting angles and a 3-dimensional space image created from the plurality of distances.
